(19) United States
(12) Patent Application Publication
(10) Pub. No.: US 2024/0313848 A1
(43) Pub. Date: Sep. 19, 2024

(54) REPEATER, NETWORK DEVICE AND COMMUNICATION METHOD THEREOF

(71) Applicant: FUJITSU LIMITED, Kawasaki-shi Kanagawa (JP)

(72) Inventors: Lei ZHANG, Beijing (CN); Qinyan JIANG, Beijing (CN); Zhe CHEN, Beijing (CN); Xin WANG, Beijing (CN)

(73) Assignee: FUJITSU LIMITED, Kawasaki-shi Kanagawa (JP)

(21) Appl. No.: 18/670,768

(22) Filed: May 22, 2024

Related U.S. Application Data
(63) Continuation of application No. PCT/CN2022/071888, filed on Jan. 13, 2022.

(30) Foreign Application Priority Data
Nov. 25, 2021 (WO) PCT/CN2021/133294

(51) Int. Cl. H04B 7/155; H04B 7/0408

(52) U.S. Cl. CPC H04B 7/15507; H04B 7/0408

(57) ABSTRACT

A communication method of a repeater includes: receiving first indication information from a network device, the first indication information being used to indicate and/or configure a first frequency resource and/or a third frequency resource, wherein the first frequency resource is used to transmit, by the repeater, a first communication signal generated by the repeater to the network device, the third frequency resource is used to receive, by the repeater, a third communication signal transmitted by the network device to the repeater; when receiving a sixth forwarding signal from a terminal equipment: amplifying the sixth forwarding signal and obtaining a second forwarding signal; and forwarding the second forwarding signal to the network device, and when receiving a fourth forwarding signal from the network device: amplifying the fourth forwarding signal and obtaining a fifth forwarding signal, and forwarding the fifth forwarding signal to the terminal equipment.

### CROSS-REFERENCE TO RELATED APPLICATION

This application is a continuation application of International Application PCT/CN2022/071888 filed on Jan. 13, 2022, and designated the U.S., which claims foreign priority to China application PCT/CN2021/133294, filed on Nov. 25, 2021, the entire contents of each are incorporated herein by reference.

### TECHNICAL FIELD

The present disclosure relates to communication field.

### BACKGROUND

Compared with traditional 3G (3rd generation mobile communication technology) and 4G (4th generation mobile communication technology) systems, 5G (5th generation mobile communication technology) systems may provide greater bandwidth and higher data rates, and may support more types of terminals and vertical services. For this reason, the deployment frequency of 5G systems is typically significantly higher than that of 3G and 4G systems. For example, 5G systems may be deployed in the millimeter wave band.

However, the higher the carrying frequency is, the more severe the fading that the signal encounters during transmission is. Therefore, in the practical deployment of 5G systems, especially in the millimeter band, how to better enhance cell coverage becomes an urgent problem to be solved.

It should be noted that, the above introduction to the background is merely for the convenience of clear and complete description of the technical solution of the present disclosure, and for the convenience of understanding of persons skilled in the art. It cannot be regarded that the above technical solution is commonly known to persons skilled in the art just because that the solution has been set forth in the background of the present disclosure.

### SUMMARY

In order to better solve the coverage problem of cellular mobile communication systems in practical deployment, it is a common deployment method that a communication signal between a terminal equipment and a network device is amplified and forwarded by using an RF Relay/Repeater. The RF repeater has relatively broad application in the practical deployment of 3G systems and 4G systems. Generally speaking, an RF repeater is a device that amplifies and forwards communication signals between the network device and the terminal equipment in an RF domain.

The inventor finds that for the coverage problem encountered in the deployment of 5G systems, use of the RF repeater for coverage enhancement is one of the feasible solutions. However, a traditional repeater does not have the ability to communicate with the network device, and is not able to obtain the related information of upstream and downstream configuration directly from the network device. Therefore, although such repeater configured in the 5G system may help to enhance signal strength, it is not flexible enough to cope with complex environmental changes, and thus is not able to achieve the same effect as deploying the same RF repeater in 3G and 4G systems.

To address at least one of the above problems, provided in the embodiments of the present disclosure are a repeater and a communication method thereof, and a network device and a communication method thereof. The repeater has the ability to communicate with the network device and communicates with the network device at a specified frequency resource by receiving network indication information, and/or forwards a signal between the network device and a third device at a specified frequency resource. The frequency resource is configured for the repeater according to the actual requirements of communication and forwarding, which helps to improve wireless resource usage efficiency. The repeater in the embodiments of the present disclosure may better enhance signal coverage under network indication and cope with environmental changes, thus improving the transmission efficiency of the entire network.

According to an aspect of embodiments of the present disclosure, there is provided with a communication method of a repeater, including:
receiving, by a repeater, first indication information from a network device, the first indication information being used to indicate and/or configure a first frequency resource and/or a second frequency resource,
wherein the first frequency resource is used for the repeater to transmit a first signal generated by the repeater to the network device, and the second frequency resource is used for the repeater to transmit a second signal not generated by the repeater to the network device.

According to another aspect of the embodiments of the present disclosure, there is provided with a repeater, including:
a receiving portion configured to receive first indication information from a network device, the first indication information being used to indicate and/or configure a first frequency resource and/or a second frequency resource,
wherein the first frequency resource is used for the repeater to transmit a first signal generated by the repeater to the network device, and the second frequency resource is used for the repeater to transmit a second signal not generated by the repeater to the network device.

According to another aspect of the embodiments of the present disclosure, there is provided with a communication method of a network device, including:
indicating and/or configuring, by a network device, a first frequency resource and/or a second frequency resource to a repeater,
wherein the first frequency resource is used for the repeater to transmit a first signal generated by the repeater to the network device, and the second frequency resource is used for the repeater to transmit a second signal not generated by the repeater to the network device.

According to another aspect of the embodiments of the present disclosure, there is provided with a network device, including:
a transmitting portion configured to indicate and/or configure a first frequency resource and/or a second frequency resource to a repeater,
wherein the first frequency resource is used for the repeater to transmit a first signal generated by the repeater to the network device, and the second frequency resource is used for the repeater to transmit a second signal not generated by the repeater to the network device.

According to another aspect of the embodiments of the present disclosure, there is provided with a communication system, including:
a network device configured to transmit first indication information, the first indication information being used to indicate and/or configure a first frequency resource and/or the second frequency resource; and
a repeater configured to receive the first indication information, wherein the first frequency resource is used for the repeater to transmit a first signal generated by the repeater to the network device, and the second frequency resource is used for the repeater to transmit a second signal not generated by the repeater to the network device.

One of the beneficial effects of the embodiments of the present disclosure is that: the frequency resources for communication and forwarding between the repeater and the network device may be configured by the network device, so that the forwarding of the repeater may be configured according to a real-time condition of the network, which may better enhance signal coverage and cope with changes in the environment and the main business in a cell, so as to improve the transmission efficiency of the entire network.

With reference to the specification and drawings below, a specific embodiment of the present disclosure is disclosed in detail, which specifies the manner in which the principle of the present disclosure can be adopted. It should be understood that the scope of the embodiments of the present disclosure is not limited. Within the scope of the spirit and clause of the appended claims, the embodiments of the present disclosure include many variations, modifications and equivalents.

The features described and/or shown for one embodiment can be used in one or more other embodiments in the same or similar manner, can be combined with the features in other embodiments or replace the features in other embodiments.

It should be emphasized that, the term “include/comprise” refers to, when being used in the text, existence of features, parts, steps or assemblies, without exclusion of existence or attachment of one or more other features, parts, steps or assemblies.

### BRIEF DESCRIPTION OF THE DRAWINGS

Elements and features described in one of the drawings or embodiments of the present disclosure may be combined with the elements and features shown in one or more other drawings or embodiments. Moreover, in the drawings, similar reference signs indicate corresponding parts in several drawings and may be used to indicate corresponding parts used in more than one embodiment.

The included drawings are used for providing further understanding on the embodiments of the present disclosure, constitute a portion of the Description, are used for illustrating the embodiments of the present disclosure and explain the principle of the present disclosure together with the literary description. Obviously, the drawings described below are merely some examples of the present disclosure, persons ordinarily skilled in the art can also obtain other drawings according to these drawings without making creative efforts. In the drawings:

FIG. 1 is a schematic diagram of an application scenario of the embodiments of the present disclosure;

FIG. 2 is another schematic diagram of an application scenario of the embodiments of the present disclosure;

FIG. 3 is a schematic diagram of a TDD repeater;

FIG. 4 is a schematic diagram of a communication method of a repeater of the embodiments of the present disclosure;

FIG. 5 is an example diagram of a repeater forwarding a downlink signal in the embodiments of the present disclosure;

FIG. 6 is an example diagram of a repeater forwarding an uplink signal in the embodiments of the present disclosure;

FIG. 7 is an example diagram of a repeater receiving a downlink signal in the embodiments of the present disclosure;

FIG. 8 is an example diagram of a repeater transmitting an uplink signal in the embodiments of the present disclosure;

FIG. 9 is an example diagram of a repeater transmitting a downlink signal in the embodiments of the present disclosure;

FIG. 10 is an example diagram of a repeater receiving a downlink signal in the embodiments of the present disclosure;

FIG. 11 is a schematic diagram of frequency resources in the embodiments of the present disclosure;

FIG. 12 is another schematic diagram of frequency resources in the embodiments of the present disclosure;

FIG. 13 is another schematic diagram of frequency resources in the embodiments of the present disclosure;

FIG. 14 is another schematic diagram of frequency resources in the embodiments of the present disclosure;

FIG. 15 is another schematic diagram of frequency resources in the embodiments of the present disclosure;

FIG. 16 is another schematic diagram of frequency resources in the embodiments of the present disclosure;

FIG. 17 is a schematic diagram of time-frequency resources in the embodiments of the present disclosure;

FIG. 18 is another schematic diagram of time-frequency resources in the embodiments of the present disclosure;

FIG. 19 is another schematic diagram of time-frequency resources in the embodiments of the present disclosure;

FIG. 20 is another schematic diagram of time-frequency resources in the embodiments of the present disclosure;

FIG. 21 is another schematic diagram of time-frequency resources in the embodiments of the present disclosure;

FIG. 22 is another schematic diagram of time-frequency resources in the embodiments of the present disclosure;

FIG. 23 is another schematic diagram of time-frequency resources in the embodiments of the present disclosure;

FIG. 24 is another schematic diagram of time-frequency resources in the embodiment of the present disclosure;

FIG. 25 is a schematic diagram of a repeater in the embodiments of the present disclosure;

FIG. 26 is a schematic diagram of a communication method of a network device in the embodiments of the present disclosure;

FIG. 27 is a schematic diagram of a network device in the embodiments of the present disclosure; and

FIG. 28 is a schematic diagram of an electronic device in the embodiments of the present disclosure.

### DETAILED DESCRIPTION

With reference to the drawings, the foregoing and other features of the present disclosure will become apparent through the following description. The Description and drawings specifically disclose the particular embodiment of the present disclosure, showing part of the embodiments in which the principle of the present disclosure can be adopted, it should be understood that the present disclosure is not limited to the described embodiments, on the contrary, the present disclosure includes all modifications, variations and equivalents that fall within the scope of the appended claims.

In embodiments of the present disclosure, the terms “first”, “second”, etc., are used to distinguish different elements by their appellation, but do not indicate the spatial arrangement or chronological order of these elements, etc., and these elements shall not be limited by the terms. The term “and/or” includes any and all combinations of one or more of the terms listed in association with the term. The terms “contain”, “include”, “have”, etc., refer to the presence of the stated feature, element, component or assembly, but do not exclude the presence or addition of one or more other features, elements, components or assemblies.

In the embodiments of the present disclosure, the singular forms “one”, “the”, etc., including the plural forms, shall be broadly understood as “a sort of” or “a kind of” and not limited to the meaning of “one”; furthermore, the term “said” shall be understood to include both the singular form and the plural form, unless it is expressly indicated otherwise in the context. In addition, the term “according to” should be understood to mean “at least partially according to . . . ”, and the term “based on” should be understood to mean “based at least partially on . . . ”, unless it is expressly indicated otherwise in the context.

In embodiments of the present disclosure, the term “communications network” or “wireless communications network” may refer to a network that complies with any of the following communication standards, such as Long Term Evolution (LTE), Enhanced Long Term Evolution (LTE-A), Wideband Code Division Multiple Access (WCDMA), High-Speed Packet Access (HSPA), etc.

In addition, the communication between the devices in the communication system can be carried out according to the communication protocol of any stage, for example, including but not being limited to 1G (generation), 2G, 2.5G, 2.75G, 3G, 4G, 4.5G and future 5G, New Radio (NR), etc., and/or other communication protocols currently known or to be developed in the future.

In the embodiments of the present disclosure, the term “network device” refers to, for example, a device in the communication system that connects a terminal equipment to the communication network and provides services to the terminal equipment. The network device may include but is not limited to: a base station (BS), an access point (AP), a transmission reception point (TRP), a broadcast transmitter, a mobile management entity (MME), a gateway, a server, a radio network controller (RNC), a base station controller (BSC), etc.

The base station may include, but is not limited to, a node B (NodeB or NB), an evolution node B (eNodeB or eNB), 5G base station (gNB), etc., and may also include a remote radio head (RRH), a remote radio unit (RRU), a relay, or a low-power node (such as femto, pico, etc.). And the term “base station” may include some or all of their functions, with each base station providing communication coverage to a specific geographic area. The term “cell” can refer to a base station and/or its coverage area, depending on the context in which the term is used.

In the embodiments of the present disclosure, the term “user equipment” (UE) refers, for example, to a device that is connected to the communication network through the network device and receives network services, and may also be referred to as “Terminal Equipment” (TE). The terminal equipment can be fixed or movable, and can also be called a mobile station (MS), a terminal, a user, a subscriber station (SS), an access terminal (AT), a station, etc.

The terminal equipment may include but is not limited to: a cellular phone, a personal digital assistant (PDA), a wireless modem, a wireless communication device, a handheld device, a machine-type communication device, a laptop computer, a cordless phone, a smart phone, a smart watch, a digital camera, etc.

For another example, in scenarios such as Internet of Things (IoT), the terminal equipment may also be a machine or an apparatus that performs monitoring or measurement, and may include, but is not limited to, a machine type communication (MTC) terminal, a vehicle communication terminal, a device to device (D2D) terminal, a machine to machine (M2M) terminal, and etc.

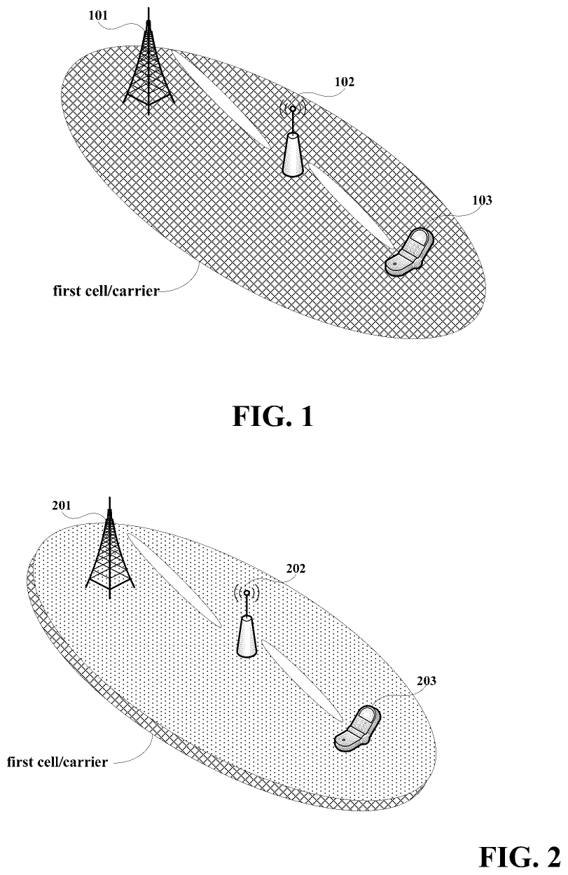

FIG. 1 is a schematic diagram of an application scenario of the embodiments of the present disclosure. As shown in FIG. 1, a network device (e.g., a 5G base station gNB) 101, a repeater 102, and a terminal equipment (UE) 103 are taken as examples for the sake of illustration, and the present disclosure is not limited to this. As shown in FIG. 1, the terminal equipment 103 establishes connection to and communicates with the network device 101. In order to increase communication quality, a signal between the terminal equipment 103 and the network device 101 is forwarded via the repeater 102. The signal interaction between the network device 101, the terminal equipment 103 and the repeater 102 adopts beam-based receiving and transmitting methods.

As shown in FIG. 1, the network device 101 may have a first cell/carrier, and the network device 101, the repeater 102 and the terminal equipment 103 may perform forwarding/communication at the first cell. However, the present disclosure is not limited to this, for example, the network device 101 may also have other cells/carriers.

FIG. 2 is another schematic diagram of an application scenario of the embodiments of the present disclosure. As shown in FIG. 2, a network device (e.g., a 5G base station gNB) 201, a repeater 202, and a terminal equipment (UE) 203 are taken as examples for the sake of illustration, and the present disclosure is not limited to this. As shown in FIG. 2, the terminal equipment 203 establishes connection to and communicates with the network device 201. In order to increase communication quality, a signal between the terminal equipment 203 and the network device 201 is forwarded via the repeater 202. The signal interaction between the network device 201, the terminal equipment 203 and the repeater 202 adopts beam-based receiving and transmitting methods.

As shown in FIG. 2, the network device 201 may have a first cell/carrier, and in addition, the network device 201 may also operate other cells/carriers in the frequency band/spectrum outside the first cell, and the network device 201, the repeater 202 and the terminal equipment 203 may perform forwarding/communication in the first cell, and may also perform forwarding/communication in other cells/carriers.

In the embodiments of the present disclosure, existing services or services that may be implemented in the future may be transmitted between the network device and the terminal equipment. For example, these services may include, but are not limited to, enhanced mobile broadband (eMBB), large-scale machine-type communications (mMTC), highly reliable low-latency communications (URLLC), and vehicle-to-vehicle (V2X) communications.

FIGS. 1 and 2 illustrates an example that the repeater can forward signals between the network device and the terminal equipment, but the present disclosure is not limited to this. For example, the repeater can act as a second device, forward signals between the first device and the third device, and may communicate directly with the first device and/or the third device; the first device through the third device may be any device in the aforementioned network. In the embodiments below, illustration is given by taking the first device as the network device and the third device as the terminal equipment.

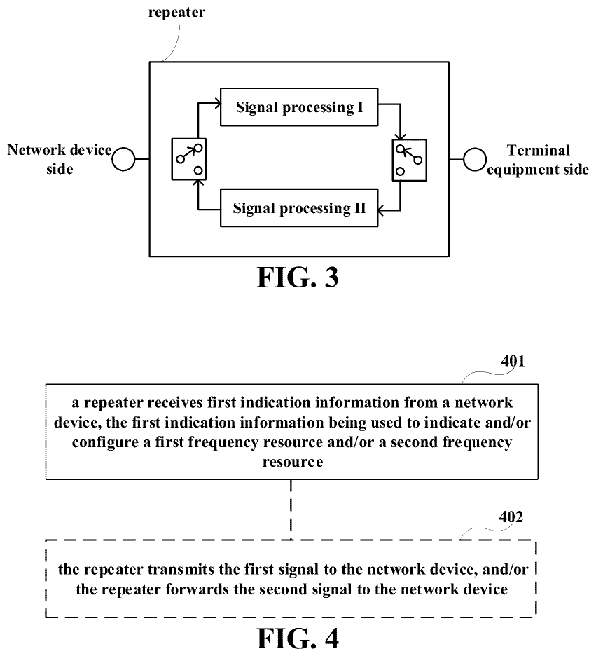

FIG. 3 is a schematic diagram of a TDD repeater. As shown in FIG. 3, a TDD (Time Division Duplex) repeater has two channels. The antennas on both sides of the repeater are aligned to areas where the network device and the terminal equipment that needs to be served possibly exist, and a signal is forwarded between the network device and the terminal equipment by a time-division mode.

A traditional repeater does not demodulate/decode the forwarded signal during the forwarding process. The antenna direction of the traditional repeater is basically fixed, and is usually manually set and adjusted during the initial installation, so that the antenna on the side of the network device is directed towards the incoming wave direction of the network device and the antenna on the side of the terminal equipment is directed towards the place where the deployment needs to be enhanced. During the operation of the traditional repeater, the antenna direction does not change. Moreover, the traditional repeater does not have a communication function and may not exchange information with the network device, and thus does not support the network device to perform adaptive and/or relatively dynamic configuration.

Compared to 3G and 4G systems, 5G systems deployed in higher frequency bands and millimeter wave bands employ more advanced and complex MIMO (multiple input multiple output) technology. In the 5G system, the directed antenna becomes a basic component of the network device and the terminal equipment, and it is a basic signal transmission method in the 5G system to transmit and receive signals based on Beam forming technology.

In particular, the characteristics of high frequency and small wavelength of the millimeter wave band are more conducive to providing antenna panels containing more arrays in the network device and the terminal equipment. The increase in the number of the antenna arrays allows for more accurate beam forming, that is, it is easier to form a narrow beam. Focusing energy on a narrow beam helps to enhance the signal while reducing interference with other devices. On the other hand, due to the precise pointing of the narrow beam, the requirements for channel measurement and beam management are very high, as a result, the 5G systems support complex but accurate channel measurement, antenna calibration, and beam management solutions, through which the network device can effectively and accurately control the receiving and transmitting beams of the terminal equipment to achieve better communication effects.

The traditional repeater does not have the ability to communicate with the network device, and the repeater needs to detect/determine by itself the relevant uplink and downlink configurations (TDD UL/DL config) in the network. Thereafter, in a downlink time unit of the network, the repeater switches to the downlink forwarding position, that is, the signal is received from the network device side, is subjected to amplification and other processing, and is sent out from the terminal equipment side; in an uplink time unit of the network, the repeater switches to the uplink forwarding position, that is, the signal is received from the terminal equipment side, is subjected to amplification and other processing, and is sent out from the network device side.

Therefore, while the traditional repeater can help enhance signal strength, it is not flexible enough to cope with complex environmental changes, which thus reduces the throughput of the overall network. In order to make the forwarding of the repeater more flexible to adapt to the characteristics of the 5G network, the network needs to assist in the repeater and can configure the forwarding the repeater according to the real-time condition of the network. The repeater needs to have the ability to communicate with the network device, may receive auxiliary information and/or configuration information, etc. (such as TDD UL DL configuration, transmitting/receiving spatial filter instructions) from the network device, and can perform necessary feedback and reporting. How to make the repeater communicate with the network device efficiently becomes an urgent problem to be solved.

The various embodiments of the present disclosure are illustrated below with reference to the accompanying drawings. These embodiments are exemplary only and are not limitations to the present disclosure.

In the embodiments of the present disclosure, a beam may also be expressed as a lobe, a reference signal (RS), a transmission configuration indication (TCI), a spatial domain filter, etc. Or, the beam may also be expressed as a beam index, a lobe index, a reference signal index, a transmission configuration indication index, a spatial domain filter index, etc. The reference signal above is, for example, a channel state information reference signal (CSI-RS), a sounding reference signal (SRS), an RS for use by the repeater, the RS sent by the repeater, etc. The above TCI can also be expressed as the TCI state.

In the embodiments of the present disclosure, the repeater may also be expressed as a repeater, an RF repeater, a relay, and an RF relay; or may also be expressed as a repeater node, a forwarder node, a relay node; or may also be expressed as an intelligent (smart) repeater, an intelligent (smart) forwarder, an intelligent (smart) relay, an intelligent (smart) repeater node, an intelligent forwarder node, an intelligent relay node etc., but the present disclosure is not limited to this.

In the embodiments of the present disclosure, the network device may be a device in a serving cell of the terminal equipment (e.g. 103), and may also be a device in the cell where the repeater is, and may further be a device in the serving cell of the repeater, and may also be a parent node of the repeater. The name of the repeater is not limited in the present disclosure, and any device that can achieve the above functions shall be included in the scope of the repeater in the present disclosure.

### Embodiments of First Aspect

An embodiment of the present disclosure provides a communication method of a repeater, illustrated from the repeater side.

FIG. 4 is a schematic diagram of a communication method of a repeater of the embodiment of the present disclosure, as shown in FIG. 4, the method including:
401, a repeater receives first indication information from a network device, the first indication information being used to indicate and/or configure a first frequency resource and/or a second frequency resource,
wherein the first frequency resource is used for the repeater to transmit a first signal generated by the repeater to the network device, and the second frequency resource is used for the repeater to transmit a second signal not generated by the repeater to the network device.

In some embodiments, the first indication information may be configured and/or indicated by one or more signaling(s); and it may be configured and/or indicated by the network device at a certain time to the repeater, or it may be configured and/or indicated by the network device to the repeater at a plurality of times through one or more of static signaling, semi-static signaling, or dynamic signaling.

For example, first indication information is used to indicate a first frequency resource, and a second frequency resource is either predefined or pre-configured or indicated by a network interface (e.g., F1). Or, first indication information is used to indicate a second frequency resource, and a first frequency resource is either predefined or pre-configured or indicated via a network interface (e.g. F1).

For another example, a piece of first indication information is used to indicate a first frequency resource and a second frequency resource.

For another example, a piece of first indication information is used to indicate a first frequency resource, and another piece of first indication information is used to indicate a second frequency resource.

For another example, a piece of first indication information is used to indicate a first frequency resource, and the second frequency resource is indicated or configured by the Operation Administration and Maintenance (OAM).

In some embodiments, alternatively, as shown in FIG. 4, the method may further include:
402, the repeater transmits the first signal to the network device, and/or, the repeater forwards the second signal to the network device.

It is worth noting that FIG. 4 above only schematically illustrates the embodiments of the present disclosure, but the present disclosure is not limited to this. For example, the order of execution between operations can be adjusted appropriately, and some other operations can be added or reduced. Those skilled in the art may make appropriate variations in accordance with the above contents, and which is not limited to the disclosure of FIG. 4 above.

In the embodiments of the present disclosure, by indicating and/or configuring the first frequency resource and/or the second frequency resource, communication bandwidth/frequency band may be distinguished from forwarding bandwidth/frequency band, and the network device may more efficiently configure the repeater, and the repeater may more efficiently forward signals between the network device and the user equipment and communicate with the network device.

Since the repeater is not a traditional terminal equipment, the repeater generally has no service data (such as video, web pages, voice calls and other typical data services of terminal equipments), the information exchange is mainly control information between the repeater and the network device, such as indication/configuration and auxiliary information of the forwarding, reporting measurement information and other control information required by the forwarding. In other words, the amount of communication data between the repeater and the network device may not be large. The network device does not need to configure a lot of frequency resources for communication to the repeater, or the bandwidth of the frequency resource for communication does not need to be very wide. On the other hand, for the repeater, the wider the forwarding bandwidth (in other words, the greater the range of the forwarding frequency), the more helpful it is to be applied in more network deployment scenarios and better assist in network deployment.

In the embodiments of the present disclosure, the communication bandwidth/frequency band and the forwarding bandwidth/frequency band are configured separately, which may help the network device to more efficiently configure the repeater, and the repeater to more efficiently forward signals between the network device and the terminal equipment and communicate with the network device. For example, the forwarding bandwidth/frequency band may be configured to be relatively wide, and the communication bandwidth/frequency band may be configured to be relatively narrow, and the embodiments of the present disclosure is not limited thereto.

Accordingly, the frequency resources for uplink communication and uplink forwarding between the repeater and the network device can be configured by the network device, and the forwarding of the repeater can be configured according to the real-time/actual condition of the network, which thus can better enhance signal coverage and cope with changes in the environment and the main business in the cell, so as to improve the transmission efficiency of the entire network.

In the embodiments of the present disclosure, “the signal generated by the repeater” includes, for example, the repeater performing signal modulation/coding, or the repeater performing sequence generation and modulation of a reference signal. “The signal not generated by the repeater” is, for example, also referred to as the forwarded signal, and the repeater does not demodulate/decode the forwarded signal, but amplifies it at most. Specific signals may be referred to the following embodiments.

In some embodiments, the first indication information is further used to indicate and/or configure a third frequency resource and/or a fourth frequency resource, wherein the third frequency resource is used for the repeater to receive a third signal transmitted by the network device to the repeater, and the fourth frequency resource is used for the repeater to receive a fourth signal from the network device that is to be forwarded by the repeater.

For example, a piece of first indication information is used to indicate a third frequency resource, and a fourth frequency resource is either predefined or pre-configured or indicated by a network interface (e.g., F1). Or, a piece of first indication information is used to indicate a fourth frequency resource, and a third frequency resource is either predefined or pre-configured or indicated by a network interface (e.g. F1).

For another example, a piece of first indication information is used to indicate a third frequency resource and a fourth frequency resource.

For another example, a piece of first indication information is used to indicate a third frequency resource, and another piece of first indication information is used to indicate a fourth frequency resource.

For another example, a piece of first indication information is used to indicate a third frequency resource, and a fourth frequency resource is indicated or configured by the OAM.

In some embodiments, the first indication information may indicate and/or configure one or any combination of the first frequency resource to the fourth frequency resource.

For example, a piece of first indication information is used to indicate the first frequency resource, another piece of first indication information is used to indicate the third frequency resource, a further piece of first indication information is used to indicate the second frequency resource, and yet another piece of first indication information is used to indicate the fourth frequency resource.

For another example, a piece of first indication information is used to indicate the first frequency resource, another piece of first indication information is used to indicate the third frequency resource; the second frequency resource and/or the fourth frequency resource are indicated or configured by the OAM.

For another example, a piece of first indication information is used to indicate the first frequency resource and the third frequency resource, another piece of first indication information is used to indicate the second frequency resource and the fourth frequency resource.

For another example, a piece of first indication information is used to indicate the first frequency resource and/or the third frequency resource, and the second frequency resource and/or the fourth frequency resource are indicated or configured by the OAM.

Accordingly, the frequency resources for downlink communication and downlink forwarding between the repeater and the network device may also be configured by the network device, and the forwarding of the repeater may be configured according to the real-time condition of the network, which thus may better enhance signal coverage and cope with changes in the environment and the main business in the cell, so as to improve the transmission efficiency of the entire network.

In some embodiments, the second frequency resource (uplink forwarding bandwidth/frequency band) and/or the fourth frequency resource (downlink forwarding bandwidth/frequency band) may be predefined or pre-configured, and/or may not be indicated by signaling. For example, the forwarding bandwidth/frequency band of the repeater (uplink forwarding bandwidth/frequency band, and/or downlink forwarding bandwidth/frequency band) may be fixed, such as when the repeater is designed. For another example, the forwarding bandwidth/frequency band of the repeater may also be set/configurable, which may be set before the repeater leaves factory, and/or during installation and debugging of the repeater.

For example, the first indication information indicates the first frequency resource, and the second frequency resource may be predefined or pre-configured.

For another example, the first indication information indicates the first frequency resource, and the second frequency resource and/or the fourth frequency resource may be predefined or pre-configured.

For another example, the first indication information indicates the first frequency resource and/or the third frequency resource, and the second frequency resource and/or the fourth frequency resource may be predefined or pre-configured.

Thus, the frequency resources for uplink forwarding and downlink forwarding between the repeater and the network device can be predefined or pre-configured, and the forwarding function can be realized through simple operations, which may reduce the cost of the repeater implementation, promote the repeater to be more and better applied in the network deployment, and improve the coverage quality and transmission efficiency of the entire network.

In some embodiments, the first signal is a signal generated by the repeater and is transmitted to the network device via the first frequency resource. The second signal is obtained by amplifying at least the signal received by the repeater at the second frequency resource. The third signal is used to carry information and/or data transmitted by the network device to the repeater, or the third signal is used to configure the repeater to perform channel estimation and/or measurement. The fourth signal is a signal received by the repeater at the fourth frequency resource, and is forwarded by the repeater after at least being amplified by the repeater.

For example, the first signal contains at least one of the following channels or signals: a Physical Uplink Shared Channel (PUSCH), a De-Modulation Reference Signal (DMRS), a Sounding Reference Signal (SRS), a Physical Random Access Channel (PRACH), a Physical Uplink Control Channel (PUCCH), or a Scheduling Request (SR); however, the present disclosure is not limited thereto.

In some embodiments, the network device indicates the repeater to receive a third signal that is associated with an ID or parameters for the repeater.

For example, the ID may be a cell ID, or a UE ID, or a repeater ID, or a Radio Network Temporary Identifier (RNTI), and so on. The parameters may be parameters configured by the network device for the repeater, for example, parameters being used to generate a reference signal sequence.

In some embodiments, the third signal is used to carry information transmitted by the network device to the repeater, and the repeater obtains the information carried by the third signal by demodulating and decoding the third signal.

In some embodiments, the third signal is used for the repeater to perform channel estimation or channel measurement, etc., and the repeater obtains channel features or channel measurement information for reporting by performing corresponding demodulation and other signal processing on the third signal.

In some embodiments, the third signal may be sent specifically to the repeater by the network device, e.g., a Physical Downlink Shared Channel (PDSCH).

In some embodiments, the third signal may also be sent by the network device to a group of devices, and the repeater is one of the devices in the group of devices. For example, the third signal may at least be one of a group common PDCCH, a Synchronization Signal Block (SSB), a Channel State Information Reference Signal (CSIRS), or a Tracking Reference Signal (TRS), etc.

For convenience, a signal that communicates directly between the network device and the repeater or between the third device (such as the terminal equipment 103) and the repeater is called a communication signal. When transmitting the communication signal, the repeater needs to perform encoding and/or modulation, and when receiving the communication signal, the repeater needs to perform decoding and/or demodulation. In addition, the signal forwarded by the repeater can be referred to as a forwarded signal, and the repeater can perform signal processing such as amplification of the forwarded signal, but may not perform decoding and/or demodulation.

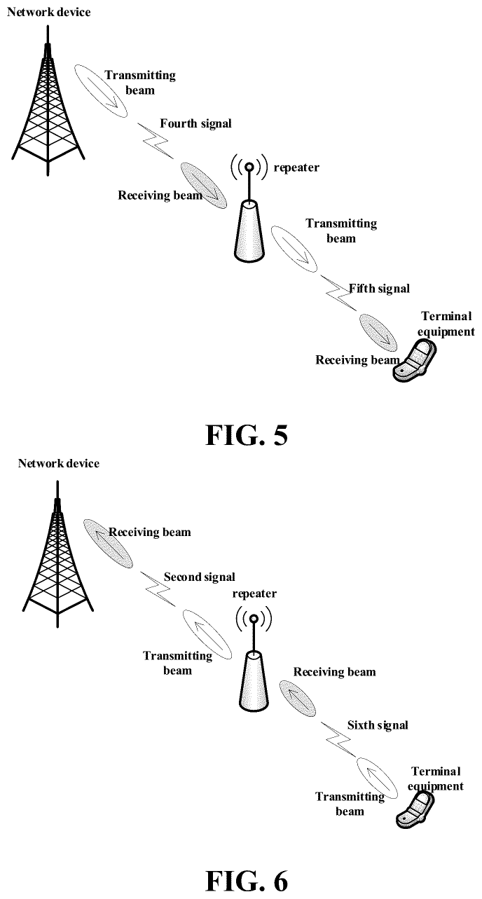

FIG. 5 is an example diagram of a repeater forwarding a downlink signal in the embodiments of the present disclosure. As shown in FIG. 5, the network device may transmit a fourth signal to the repeater by using a transmitting beam, and the fourth signal is used, for example, for scheduling the terminal equipment. The repeater receives the fourth signal by using a receiving beam (for example, being indicated or configured by the network device, or for example, being predefined) and performs signal processing (such as amplification) on the fourth signal to generate a fifth signal. The repeater may transmit the fifth signal to the terminal equipment by using a transmitting beam (for example, being indicated or configured by the network device, or for example, being predefined). The terminal equipment receives the fifth signal by using the receiving beam (for example, also indicated or configured by the network device, or for example predefined).

FIG. 6 is an example diagram of a repeater forwarding an uplink signal in the embodiments of the present disclosure. As shown in FIG. 5, the terminal equipment transmits a sixth signal by using a transmitting beam (e.g. indicated or configured by the network device, or e.g. predefined), and the sixth signal is, for example, reported by the terminal equipment to the network device. The repeater receives the sixth signal by using a receiving beam (being indicated or configured by the network device, or for example, being predefined) and performs signal processing (such as amplification) on the sixth signal to generate the second signal. The repeater may transmit the second signal to the network device by using a transmitting beam (for example, being indicated or configured by the network device, or for example, being predefined). The network device may receive the second signal transmitted by the repeater by using the receiving beam.

Exemplary illustration has been made hereinabove as to the signals (including a forwarded signal in uplink and a forwarded signal in downlink) between the network device and the terminal equipment that is forwarded by the repeater, and the communication signal (including a communication signal in uplink and a communication signal in downlink) between the repeater and the network device is illustrated hereinafter.

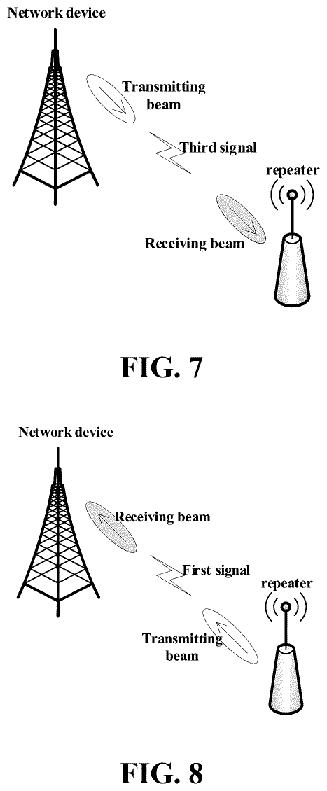

FIG. 7 is an example diagram of a repeater receiving a downlink signal in the embodiments of the present disclosure. As shown in FIG. 7, the network device may transmit a third signal to the repeater by using a transmitting beam, and the third signal is used, for example, for scheduling or configuring the repeater. The repeater receives the third signal by using the receiving beam (for example, being indicated or configured by the network device, or for example, being predefined) and demodulates and/or decodes the third signal, so as to perform corresponding processing according to the content carried by the third signal, such as acquiring information carried by the third signal and/or performing channel estimation or channel measurement by using a reference signal carried by the third signal.

FIG. 8 is an example diagram of a repeater transmitting an uplink signal in the embodiments of the present disclosure. As shown in FIG. 8, the repeater generates (e.g. including modulation/coding) the first signal, which is for example used by the repeater to report measurement results or feedback information to the network device. The repeater may transmit the first signal to the network device by using a transmitting beam (for example, being indicated or configured by the network device, or for example, being predefined). The network device may receive the first signal transmitted by the repeater by using the receiving beam, so as to perform corresponding processing according to the content carried by the first signal.

In some embodiments, the repeater may forward the signal between the network device and the third device (such as the terminal equipment), and in addition, may communicate directly with the network device, as shown in FIG. 5 to FIG. 8. FIG. 5 to FIG. 8 provide exemplary illustrations of the forwarded signal and the communication signal respectively, but the present disclosure is not limited to this.

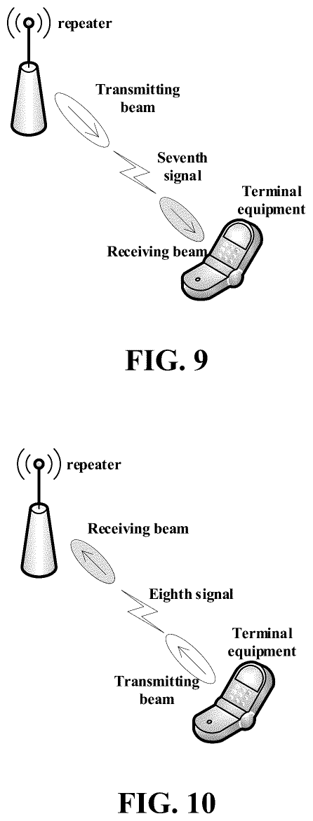

In some embodiments, the repeater may forward the signal between the network device and the third device (such as the terminal equipment), and may communicate directly with the network device; in addition, the repeater may communicate directly with the third device (such as the terminal equipment). That is, on the basis of FIG. 5 to FIG. 8, the repeater may also carry out the communication as shown in FIG. 9 and FIG. 10.

FIG. 9 is an example diagram of a repeater transmitting a downlink signal in the embodiments of the present disclosure. As shown in FIG. 9, the repeater generates (for example including modulates/encodes, or generates and modulates sequence of reference signals) a seventh signal, which is used, for example, by the terminal equipment for channel measurement or estimation (of e.g., a reference signal), or for the repeater to transmit information or data or the like to the terminal equipment, etc. The repeater may transmit the seventh signal to the terminal equipment by using a transmitting beam (for example, being indicated or configured by the network device, or for example, being predefined). The terminal equipment may receive the seventh signal transmitted by the repeater by using the receiving beam, so as to perform corresponding processing according to the content carried by the seventh signal.

FIG. 10 is an example diagram of a repeater receiving an uplink signal in the embodiments of the present disclosure. As shown in FIG. 10, the terminal equipment may transmit the eighth signal to the repeater by using a transmitting beam, and the eighth signal is used for the repeater to perform channel measurement or estimation (of, e.g., a reference signal), or for the terminal equipment to transmit information or data or the like to the repeater. The repeater receives the eighth signal by using the receiving beam (for example, being indicated or configured by the network device, or for example, being predefined) and demodulates and/or decodes the eighth signal, so as to perform corresponding processing according to the content carried by the eighth signal.

The respective signals are schematically illustrated hereinabove, and the first cell and frequency resources are described below.

In some embodiments, a first frequency resource and/or a second frequency resource are indicated and/or configured in the first cell of the network device, for the repeater.

In some embodiments, the first frequency resource and the second frequency resource overlap.

In some embodiments, the first frequency resource and the second frequency resource do not overlap.

In some embodiments, the first frequency resource is an uplink carrier to which a first cell corresponds, or an uplink bandwidth part (BWP) configured and/or indicated by the network device for the repeater, or an active uplink BWP configured by the network device for the repeater.

In some embodiments, the second frequency resource at least includes a frequency resource other than the first frequency resource.

For example, the second frequency resource contains the first frequency resource.

For another example, the second frequency resource does not contain the first frequency resource.

In some embodiments, the second frequency resource and the first frequency resource are the same.

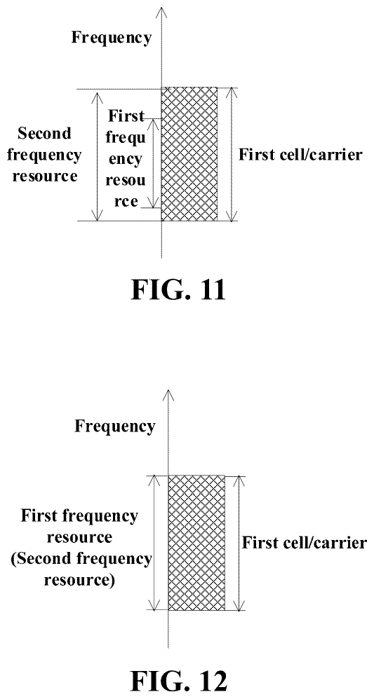

FIG. 11 is a schematic diagram of frequency resources in the embodiments of the present disclosure. As shown in FIG. 11, the first frequency resource and the second frequency resource may be different. The first frequency resource and the second frequency resource may both be located in the first cell/carrier in frequency, and the bandwidth of the first frequency resource is less than that of the second frequency resource.

FIG. 12 is another schematic diagram of frequency resources in the embodiments of the present disclosure. As shown in FIG. 12, the first frequency resource and the second frequency resource may be the same. The first frequency resource and the second frequency resource may both be located in the first cell/carrier in frequency, and the bandwidth of the first frequency resource is equal to that of the second frequency resource.

FIG. 13 is another schematic diagram of frequency resources in the embodiments of the present disclosure. As shown in FIG. 13, the first frequency resource and the second frequency resource may be different. The first frequency resource is located in the first cell/carrier, while only part of the second frequency resource is located in the first cell/carrier; and the bandwidth of the first frequency resource is less than that of the second frequency resource. In addition, as shown in FIG. 13, there may be other cells/carriers. There may be gap between the frequency resources of the first cell and other cells, or there may be no gap.

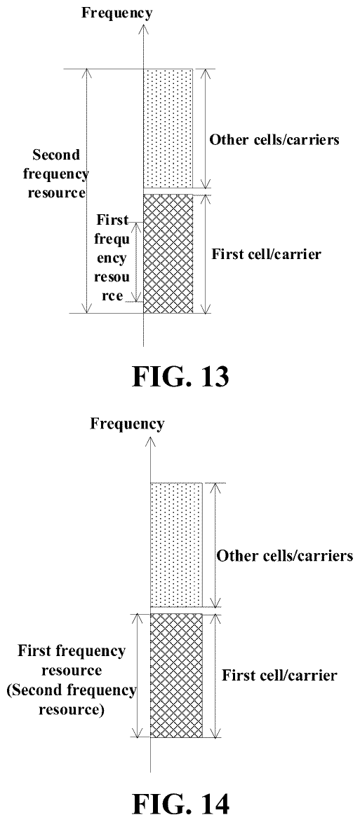

FIG. 14 is another schematic diagram of frequency resources in the embodiments of the present disclosure. As shown in FIG. 14, the first frequency resource and the second frequency resource may be the same. The first frequency resource and the second frequency resource may both be located in the first cell/carrier in frequency, and the bandwidth of the first frequency resource is equal to that of the second frequency resource. In addition, as shown in FIG. 14, there may be other cells/carriers. There may be gap between the frequency resources of the first cell and other cells, or there may be no gap.

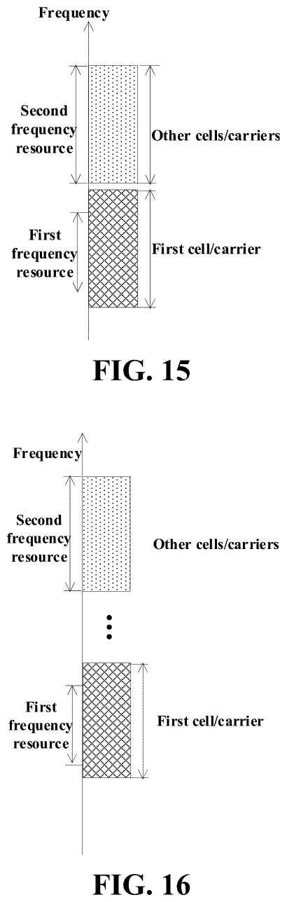

FIG. 15 is another schematic diagram of frequency resources in the embodiments of the present disclosure. As shown in FIG. 15, the first frequency resource and the second frequency resource may be different. The first frequency resource is located in the first cell/carrier, and the bandwidth of the first frequency resource is less than that of the first cell/carrier; and the second frequency resource does not overlap with the first cell/carrier, for example, located in other cells/carriers. In addition, as shown in FIG. 15, there may be gap between the frequency resources of the first cell and other cells, or there may be no gap.

FIG. 16 is another schematic diagram of frequency resources in the embodiments of the present disclosure. As shown in FIG. 16, the first frequency resource and the second frequency resource may be different. The first frequency resource is located in the first cell/carrier, and the bandwidth of the first frequency resource is less than that of the first cell/carrier; and the second frequency resource does not overlap with the first cell/carrier, for example, located in other cells/carriers. In addition, as shown in FIG. 16, the frequency resources of the first cell and the other cells are located in different frequency bands (bands), such as one in FRI and the other in FR2.

In some embodiments, the network device indicates the first frequency resource and/or the second frequency resource to the repeater by Radio Resource Control (RRC) signaling or Media Access Control (MAC) signaling or a physical layer control channel (such as PDCCH).

In some embodiments, the signaling or information element (IE) used to indicate the second frequency resource is different from the signaling or information element (IE) used to indicate the first frequency resource.

For example, both the first frequency resource and the second frequency resource are indicated by the IE of the RRC, and the IE used to indicate the first frequency resource can be configured in servingCellConfig, while the IE used to indicate the second frequency resource can be configured by the IE used to configure forwarding of the repeater.

In some embodiments, the network device also indicates to the repeater the starting frequency and ending frequencies of the first frequency resource and/or the second frequency resource.

In some embodiments, the network device also indicates to the repeater the center frequency and bandwidth of the first frequency resource and/or the second frequency resource.

In some embodiments, the network device also indicates to the repeater the starting frequency and bandwidth of the first frequency resource and/or the second frequency resource.

The first frequency resource and the second frequency resource are schematically illustrated hereinabove, but the present disclosure is not limited thereto.

In some embodiments, a third frequency resource and/or a fourth frequency resource are indicated and/or configured in the first cell of the network device, for the repeater.

In some embodiments, the third frequency resource and the fourth frequency resource overlap.

In some embodiments, the third frequency resource and the fourth frequency resource do not overlap.

In some embodiments, the third frequency resource is a downlink carrier to which a first cell corresponds, or a downlink bandwidth part (BWP) configured and/or indicated by the network device for the repeater, or an active downlink BWP configured by the network device for the repeater.

In some embodiments, the fourth frequency resource at least includes a frequency resource other than the third frequency resource.

For example, the fourth frequency resource contains a third frequency resource.

For another example, the fourth frequency resource does not contain a third frequency resource.

In some embodiments, the fourth frequency resource and the third frequency resource are the same.

In some embodiments, the network device indicates a third frequency resource and/or a fourth frequency resource to the repeater via RRC signaling or MAC signaling or a physical layer control channel.

In some embodiments, the signaling or information element (IE) used to indicate the fourth frequency resource is different from the signaling or information element (IE) used to indicate the third frequency resource.

In some embodiments, the network device also indicates to the repeater the starting frequency and ending frequencies of the third frequency resource and/or the fourth frequency resource.

In some embodiments, the network device also indicates to the repeater the center frequency and bandwidth of the third frequency resource and/or the fourth frequency resource.

In some embodiments, the network device also indicates to the repeater the starting frequency and bandwidth of the third frequency resource and/or the fourth frequency resource.

In addition, the third frequency resource and/or the fourth frequency resource may be similar to that of FIG. 11 to FIG. 16, which are omitted here.

In some embodiments, a center frequency of the fourth frequency resource is identical to a center frequency of the second frequency resource, and/or, a bandwidth of the fourth frequency resource is greater than a bandwidth of the second frequency resource.

In some embodiments, the first cell is a serving cell of the repeater. For example, the first cell is the primary cell of the repeater; however, the present disclosure is not limited thereto, for example, it can also be the auxiliary cell of the repeater.

In some embodiments, the first cell is a cell where the repeater performs initial access; and/or, the first cell is a cell where the repeater establishes RRC connection with the network device; and/or, the first cell is a cell where the repeater reestablishes RRC connection with the network device; and/or, the first cell is a cell where the repeater camps; and/or, the first cell is a cell selected by the repeater in a cell selection process or in a cell reselection process.

In some embodiments, the first signal is generated by the repeater using at least the cell ID of the first cell, or the generation of the first signal is related to the cell ID of the first cell.

For example, the first signal includes DMRS, and the sequence generation of the DMRS is related to the cell ID.

For another example, the first signal includes PUSCH, the scrambler sequence of the PUSCH is related to the cell ID.

In some embodiments, the signal received by the repeater at the second frequency resource at least includes a signal from a third device (such as the terminal equipment), and the signal from the third device is generated and transmitted by the third device according to an indication of the network device.

In some embodiments, the signal from the third device is related to a cell identifier (ID) of a first cell.

In some embodiments, the first cell is a serving cell of the third device.

In some embodiments, the first cell is not a serving cell of the third device.

In some embodiments, the network device indicates or configures the repeater to transmit a first signal to the network device using a first spatial filter; and the first spatial filter is also used by the repeater to transmit a second signal to the network device.

In some embodiments, the network device indicates or configures the repeater to receive a third signal transmitted by the network device using a second spatial filter; and the second spatial filter is also used for the repeater to receive a fourth signal transmitted by the network device.

In some embodiments, the repeater receives second indication information from the network device, the second indication information is used to indicate and/or configure a first time unit and/or a second time unit, the first time unit is available for transmitting, by the repeater, a first signal generated by the repeater to the network device, and the second time unit is available for transmitting, by the repeater, a second signal that is not generated by the repeater to the network device.

In some embodiments, the time unit is at least one of a symbol, slot, or a subframe. For example, it can be a symbol, it can also be a slot, or can also include both symbol and slot, and so on, and the application is not limited thereto.

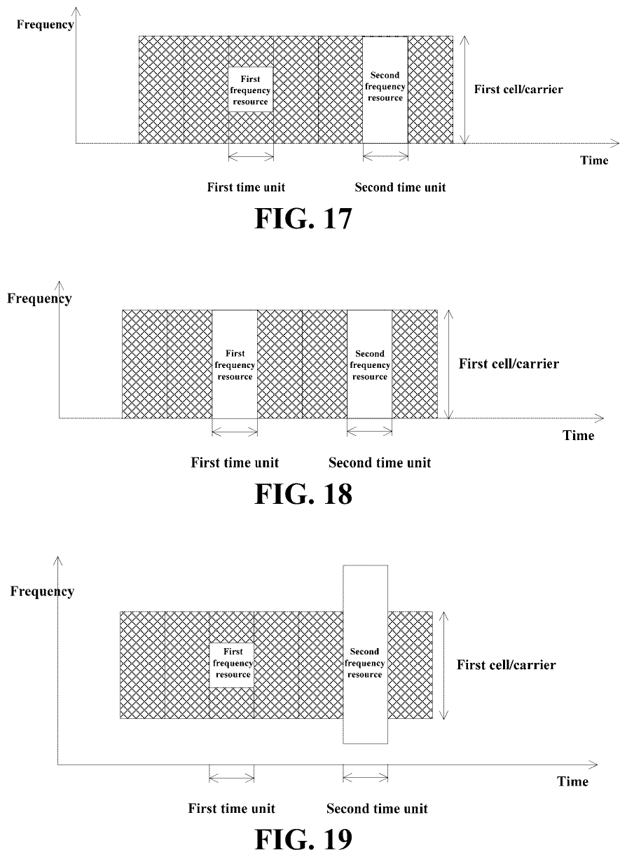

FIG. 17 is a schematic diagram of time-frequency resources in the embodiments of the present disclosure. As shown in FIG. 17, the first time unit for transmitting the first signal by the repeater is different from the second time unit for transmitting the second signal, and in addition, the first frequency resource and the second frequency resource are also different. As shown in FIG. 17, the first frequency resource and the second frequency resource may both be located in the first cell/carrier in frequency, and the bandwidth of the first frequency resource is less than that of the second frequency resource.

FIG. 18 is another schematic diagram of time-frequency resources in the embodiments of the present disclosure. As shown in FIG. 18, the first time unit for transmitting the first signal by the repeater is different from the second time unit for transmitting the second signal, and in addition, the first frequency resource and the second frequency resource are the same. As shown in FIG. 18, the first frequency resource and the second frequency resource may both be located in the first cell/carrier in frequency, and the bandwidth of the first frequency resource is equal to that of the second frequency resource.

FIG. 19 is another schematic diagram of time-frequency resources in the embodiments of the present disclosure. As shown in FIG. 19, the first time unit for transmitting the first signal by the repeater is different from the second time unit for transmitting the second signal, and in addition, the first frequency resource and the second frequency resource are also different. As shown in FIG. 19, the first frequency resources may all be located in the first cell/carrier, and the second frequency resources may be partially located in the first cell/carrier; and the bandwidth of the first frequency resource is less than that of the second frequency resource, and the bandwidth of the second frequency resource may be greater than that of the first cell/carrier.

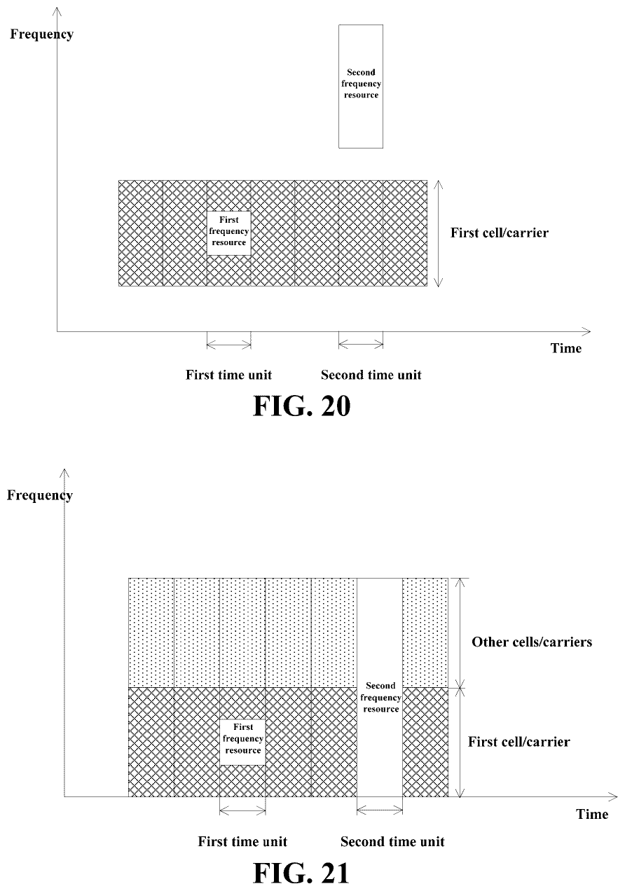

FIG. 20 is another schematic diagram of time-frequency resources in the embodiments of the present disclosure. As shown in FIG. 20, the first time unit for transmitting the first signal by the repeater is different from the second time unit for transmitting the second signal, and in addition, the first frequency resource and the second frequency resource are also different. As shown in FIG. 20, the first frequency resources may all be located in the first cell/carrier, and the second frequency resource do not overlap with the first cell/carrier in frequency; and the bandwidth of the first frequency resource is less than that of the second frequency resource.

FIG. 21 is another schematic diagram of time-frequency resources in the embodiments of the present disclosure. As shown in FIG. 21, the first time unit for transmitting the first signal by the repeater is different from the second time unit for transmitting the second signal, and in addition, the first frequency resource and the second frequency resource are also different.

As shown in FIG. 21, the first frequency resource is located in the first cell/carrier in frequency, and the bandwidth of the first frequency resource is less than that of the first cell/carrier. Part of the second frequency resource is located in the first cell/carrier, and the other part thereof is located in other cells/carriers; and the bandwidth of the first frequency resource is less than that of the second frequency resource, and the bandwidth of the second frequency resource is greater than that of the first cell/carrier.

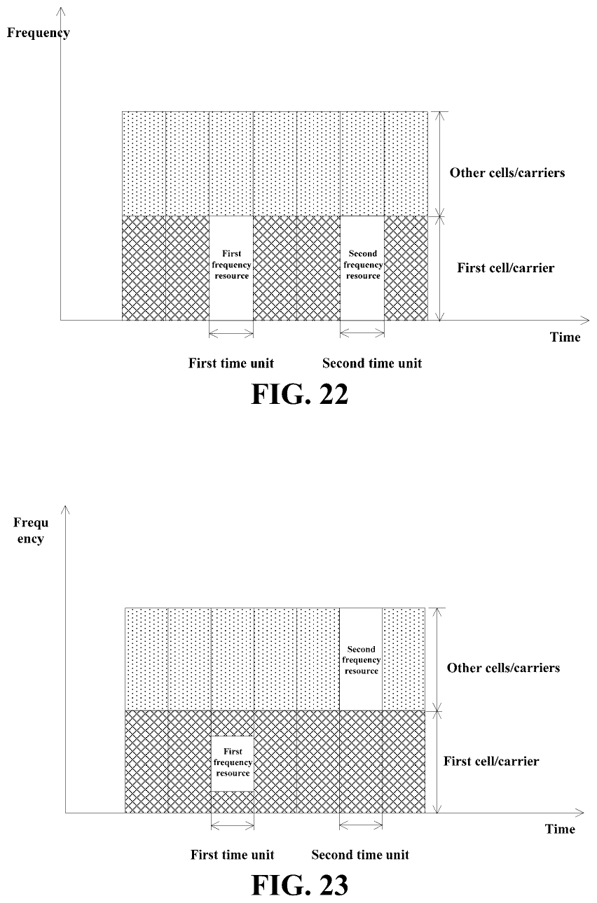

FIG. 22 is another schematic diagram of time-frequency resources in the embodiments of the present disclosure. As shown in FIG. 22, the first time unit for transmitting the first signal by the repeater is different from the second time unit for transmitting the second signal, and in addition, the first frequency resource and the second frequency resource are the same. As shown in FIG. 22, the first frequency resource and the second frequency resource may both be located in the first cell/carrier in frequency, and the bandwidth of the first frequency resource is equal to that of the second frequency resource. In addition, there may be other cells/carriers.

FIG. 23 is another schematic diagram of time-frequency resources in the embodiments of the present disclosure. As shown in FIG. 23, the first time unit for transmitting the first signal by the repeater is different from the second time unit for transmitting the second signal, and in addition, the first frequency resource and the second frequency resource are also different.

As shown in FIG. 23, the first frequency resource is located in the first cell/carrier in frequency, and the second frequency resource is located in other cells/carriers in frequency; and the bandwidth of the first frequency resource is less than that of the first cell/carrier, and the bandwidth of the second frequency resource is equal to that of other cells/carriers.

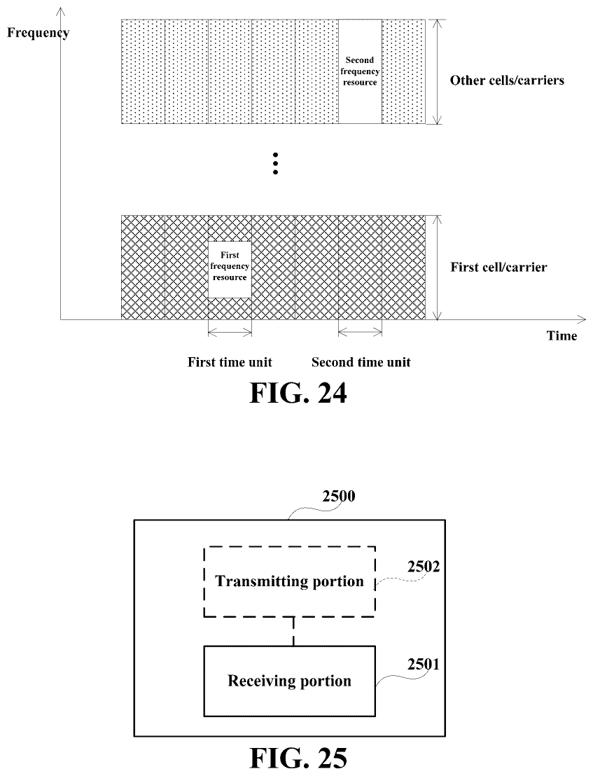

FIG. 24 is another schematic diagram of time-frequency resources in the embodiments of the present disclosure. As shown in FIG. 24, the first time unit for transmitting the first signal by the repeater is different from the second time unit for transmitting the second signal, and in addition, the first frequency resource and the second frequency resource are also different.

As shown in FIG. 24, the first frequency resource is located in other cells/carriers in frequency, and the second frequency resource is located in another cell/carrier in frequency; and the bandwidth of the first frequency resource is less than that of the cell/carrier, and the bandwidth of the second frequency resource is equal to that of the cell/carrier. In addition, as shown in FIG. 24, the frequency resources of two other cells are located in different frequency bands (bands), such as one in FRI and the other in FR2.

The frequency resource and the time-frequency resource are schematically illustrated hereinabove, but the present disclosure is not limited thereto.

Only the steps or processes related to the present disclosure are illustrated hereinabove, but the present disclosure is not limited to this. The method of the embodiments of the present disclosure may also include other steps or processes, and the details of these steps or processes can be seen by referring to the related art.

The embodiments above only schematically illustrate the embodiments of the present disclosure, but the present disclosure is not limited to this, and appropriate variations can also be made on the basis of the above embodiments. For example, the above embodiments may be used separately, or one or more of the above embodiments may be combined.

In accordance with the embodiments of the present disclosure, the frequency resources for communication and forwarding between the repeater and the network device can be configured by the network device, so that the forwarding of the repeater may be configured according to the real-time condition of the network, which may better enhance signal coverage and cope with changes in the environment and the main business in the cell, so as to improve the transmission efficiency of the entire network.

### Embodiments of Second Aspect

An embodiment of the present disclosure provides a repeater that may, for example, be a network device or a terminal equipment, or some one or more components or assemblies configured on a network device or a terminal equipment.

FIG. 25 is a schematic diagram of a repeater in the embodiment of the present disclosure. Since the principle for the repeater to solve the problem is the same as the method of the embodiments of the first aspect, the specific implementation can be realized referring to the embodiments of the first aspect, and the same contents will not be repeated.

As shown in FIG. 25, a repeater 2500 of the embodiments of the present disclosure includes:
a receiving portion 2501 configured to receive first indication information from a network device, the first indication information being used to indicate and/or configure a first frequency resource and/or a second frequency resource,
wherein the first frequency resource is used for the repeater to transmit a first signal generated by the repeater to the network device, and the second frequency resource is used for the repeater to transmit a second signal not generated by the repeater to the network device.

In some embodiments, as shown in FIG. 25, the repeater 2500 may further include:
a transmitting portion 2502 configured to transmit the first signal to the network device, and/or forward the second signal to the network device.

In some embodiments, the first indication information is further used to indicate and/or configure a third frequency resource and/or a fourth frequency resource, wherein the third frequency resource is used for the repeater to receive a third signal transmitted by the network device to the repeater, and the fourth frequency resource is used for the repeater to receive a fourth signal from the network device that is to be forwarded by the repeater.

In some embodiments, the second signal is obtained by the repeater at least by amplifying a signal received by the repeater at the second frequency resource;
the third signal is used to carry information and/or data transmitted by the network device to the repeater, or the third signal is used to configure the repeater to perform channel estimation and/or measurement;
the fourth signal is a signal received by the repeater at the fourth frequency resource, and is forwarded by the repeater after at least being amplified by the repeater.

In some embodiments, the receiving portion 2501 receives the first indication information at a first cell of the network device.

In some embodiments, the first cell is a serving cell of the repeater; and/or,
the first cell is a cell where the repeater performs initial access; and/or,
the first cell is a cell where the repeater establishes radio resource control connection with the network device; and/or,
the first cell is a cell where the repeater reestablishes radio resource control connection with the network device; and/or,
the first cell is a cell where the repeater camps; and/or,
the first cell is a cell selected by the repeater in a cell selection process or in a cell reselection process.

In some embodiments, the first signal includes at least one of the following: a physical uplink shared channel (PUSCH), a demodulation reference signal (DMRS), a sounding reference signal (SRS), a physical random access channel (PRACH), a physical uplink control channel (PUCCH), or a scheduling request (SR).

In some embodiments, the first signal is generated by the repeater by at least using a cell identifier of a first cell, or generation of the first signal is related to a cell identifier of the first cell.

In some embodiments, the signal received by the receiving portion 2501 at the second frequency resource at least includes a signal from a third device, the signal from the third device being generated and transmitted by the third device according to an indication of the network device.

In some embodiments, the signal from the third device is related to a cell identifier of a first cell.

In some embodiments, the first frequency resource and the second frequency resource overlap.

In some embodiments, the first frequency resource and the second frequency resource do not overlap.

In some embodiments, the first frequency resource is an uplink carrier to which a first cell corresponds, or an uplink bandwidth part configured and/or indicated by the network device for the repeater, or an active uplink bandwidth part configured by the network device for the repeater.

In some embodiments, the second frequency resource at least includes a frequency resource other than the first frequency resource.

In some embodiments, the second frequency resource and the first frequency resource are the same.

In some embodiments, the first indication information further indicates: a starting frequency/frequencies and an ending frequency/frequencies of the first frequency resource and/or the second frequency resource, or a center frequency/frequencies and a bandwidth(s) of the first frequency resource and/or the second frequency resource, or a starting frequency/frequencies and bandwidth(s) of the first frequency resource and/or the second frequency resource.

In some embodiments, the repeater transmits the first signal to the network device by using a first spatial filter, the first spatial filter being further used for the repeater to transmit the second signal to the network device.

In some embodiments, the third frequency resource and the fourth frequency resource overlap.

In some embodiments, the third frequency resource and the fourth frequency resource do not overlap.

In some embodiments, the third frequency resource is a downlink carrier to which a first cell corresponds, or a downlink bandwidth part configured and/or indicated by the network device for the repeater, or an active downlink bandwidth part configured by the network device for the repeater.

In some embodiments, a center frequency of the fourth frequency resource is identical to a center frequency of the second frequency resource, and/or, a bandwidth of the fourth frequency resource is greater than a bandwidth of the second frequency resource.

In some embodiments, the receiving portion 2501 is further used to receive second indication information from the network device, the second indication information is used to indicate and/or configure a first time unit and/or a second time unit, the first time unit is available for transmitting, by the repeater, a first signal generated by the repeater to the network device, and the second time unit is available for transmitting, by the repeater, a second signal that is not generated by the repeater to the network device.

In addition, for the sake of simplicity, FIG. 25 only exemplarily shows the connection relationship or signal trend between the individual components or modules, but it should be clear to those skilled in the art that various related techniques such as bus connections can be employed. The above individual components or modules can be implemented by hardware facilities such as a processor, a memory, a transmitter, a receiver, etc., which is not limited in the present disclosure.

The embodiments above only schematically illustrate the embodiments of the present disclosure, but the present disclosure is not limited to this, and appropriate variations can also be made on the basis of the above embodiments. For example, the above embodiments may be used separately, or one or more of the above embodiments may be combined.

In accordance with the embodiments of the present disclosure, the frequency resources for communication and forwarding between the repeater and the network device may be configured by the network device, so that the forwarding of the repeater may be configured according to the real-time condition of the network, which may better enhance signal coverage and cope with changes in the environment and the main business in the cell, so as to improve the transmission efficiency of the entire network.

### Embodiments of Third Aspect

An embodiment of the present disclosure provides a communication method of a network device, and is explained from the network device side, and the same content as the embodiment of the first aspect is not be repeated.

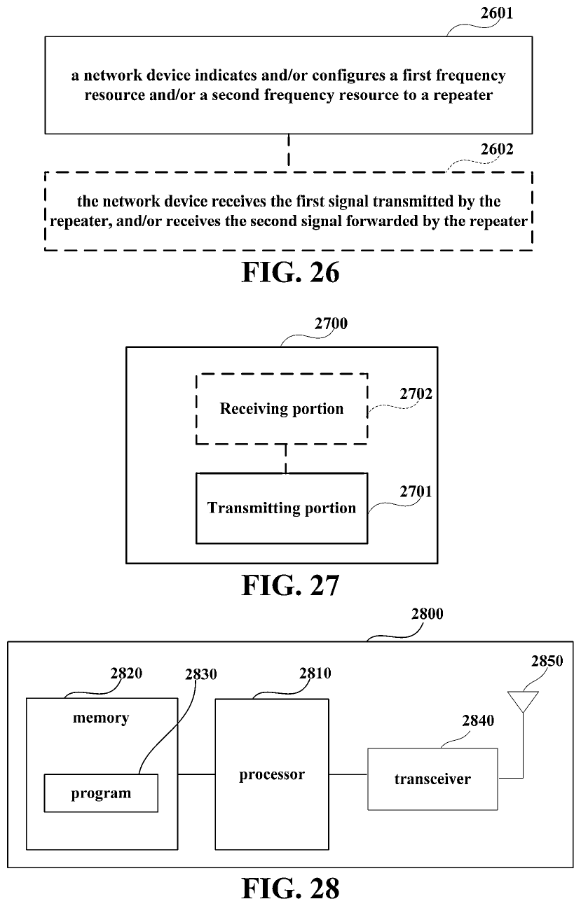

FIG. 26 is a schematic diagram of a communication method of a network device of the embodiment of the present disclosure, as shown in FIG. 26, the method including:
2601, a network device indicates and/or configures a first frequency resource and/or a second frequency resource to a repeater,
wherein the first frequency resource is used for the repeater to transmit a first signal generated by the repeater to the network device, and the second frequency resource is used for the repeater to transmit a second signal not generated by the repeater to the network device.

In some embodiments, alternatively, as shown in FIG. 26, the method may further include:
2602, the network device receives the first signal transmitted by the repeater, and/or receives the second signal forwarded by the repeater.

It is worth noting that FIG. 26 above only schematically illustrates the embodiments of the present disclosure, but the present disclosure is not limited to this. For example, the order of execution between operations can be adjusted appropriately, and some other operations can be added or reduced. Those skilled in the art may make appropriate variations in accordance with the above contents, and which is not limited to the disclosure of FIG. 26 above.

In some embodiments, the network device indicates and/or configures a third frequency resource and/or a fourth frequency resource to the repeater, wherein the third frequency resource is used for the repeater to receive a third signal transmitted by the network device to the repeater, and the fourth frequency resource is used for the repeater to receive a fourth signal from the network device that is to be forwarded by the repeater.

In some embodiments, the second signal is obtained by the repeater at least by amplifying a signal received by the repeater at the second frequency resource.

In some embodiments, the third signal is used to carry information and/or data transmitted by the network device to the repeater, or the third signal is used to configure the repeater to perform channel estimation and/or measurement.

In some embodiments, the fourth signal is a signal received by the repeater at the fourth frequency resource, and is forwarded by the repeater after at least being amplified by the repeater.

In some embodiments, the first frequency resource and/or the second frequency resource are indicated and/or configured in the first cell of the network device, for the repeater.

In some embodiments, the third frequency resource and/or the fourth frequency resource are indicated and/or configured in the first cell of the network device, for the repeater.

In some embodiments, the first cell is a serving cell of the repeater.

For example, the first cell is the primary cell of the repeater.

In some embodiments, the first cell is a cell where the repeater performs initial access; and/or,
the first cell is a cell where the repeater establishes RRC connection with the network device; and/or,
the first cell is a cell where the repeater reestablishes RRC connection with the network device; and/or,
the first cell is a cell where the repeater camps; and/or,
the first cell is a cell selected by the repeater in a cell selection process or in a cell reselection process.

In some embodiments, the first signal includes at least one of the following: a physical uplink shared channel (PUSCH), a demodulation reference signal (DMRS), a sounding reference signal (SRS), a physical random access channel (PRACH), a physical uplink control channel (PUCCH), or a scheduling request (SR).

In some embodiments, the first signal is generated by the repeater by at least using the cell ID of the first cell, or generation of the first signal is related to the cell ID of the first cell.

In some embodiments, the first signal includes DMRS, and the sequence generation of the DMRS is related to the cell ID, and/or, the first signal includes PUSCH, and the scrambler sequence of the PUSCH is related to the cell ID.

In some embodiments, the first frequency resource and the second frequency resource overlap.

In some embodiments, the first frequency resource and the second frequency resource do not overlap.

In some embodiments, the first frequency resource is an uplink carrier to which a first cell corresponds, or an uplink bandwidth part (BWP) configured and/or indicated by the network device for the repeater, or an active uplink BWP configured by the network device for the repeater.

In some embodiments, the second frequency resource at least includes a frequency resource other than the first frequency resource.

In some embodiments, the second frequency resource contains the first frequency resource.

In some embodiments, the second frequency resource does not contain the first frequency resource.

In some embodiments, the second frequency resource and the first frequency resource are the same.

In some embodiments, the network device indicates the first frequency resource and/or the second frequency resource to the repeater via RRC signaling or MAC signaling or a physical layer control channel.

In some embodiments, the signaling or information element (IE) used to indicate the second frequency resource is different from the signaling or information element (IE) used to indicate the first frequency resource.

In some embodiments, the network device further indicates to the repeater a starting frequency/frequencies and an ending frequency/frequencies of the first frequency resource and/or the second frequency resource, or a center frequency/frequencies and a bandwidth(s) of the first frequency resource and/or the second frequency resource, or a starting frequency/frequencies and bandwidth(s) of the first frequency resource and/or the second frequency resource.

In some embodiments, the network device indicates or configures the repeater to transmit the first signal to the network device using a first spatial filter; and the first spatial filter is also used for the repeater to transmit the second signal to the network device.

In some embodiments, the third frequency resource and the fourth frequency resource overlap.

In some embodiments, the third frequency resource and the fourth frequency resource do not overlap.

In some embodiments, the third frequency resource is a downlink carrier to which a first cell corresponds, or a downlink bandwidth part (BWP) configured and/or indicated by the network device for the repeater, or an active downlink BWP configured by the network device for the repeater.

In some embodiments, the fourth frequency resource at least includes a frequency resource other than the third frequency resource.

In some embodiments, the fourth frequency resource contains the third frequency resource.

In some embodiments, the fourth frequency resource does not contain the third frequency resource.

In some embodiments, the fourth frequency resource and the third frequency resource are the same.

In some embodiments, the network device indicates the third frequency resource and/or the fourth frequency resource to the repeater via RRC signaling or MAC signaling or a physical layer control channel.

In some embodiments, the signaling or information element (IE) used to indicate the fourth frequency resource is different from the signaling or information element (IE) used to indicate the third frequency resource.

In some embodiments, the network device further indicates to the repeater a starting frequency/frequencies and an ending frequency/frequencies of the third frequency resource and/or the fourth frequency resource, or a center frequency/frequencies and a bandwidth(s) of the third frequency resource and/or the fourth frequency resource, or a starting frequency/frequencies and bandwidth(s) of the third frequency resource and/or the fourth frequency resource.

In some embodiments, the network device indicates or configures the repeater to receive the third signal transmitted by the network device using a second spatial filter; and the second spatial filter is also used for the repeater to receive the fourth signal transmitted by the network device.

In some embodiments, a center frequency of the fourth frequency resource is identical to a center frequency of the second frequency resource, and/or, a bandwidth of the fourth frequency resource is greater than a bandwidth of the second frequency resource.

In some embodiments, the network device indicates and/or configures the first time unit to the repeater, and the first time unit is available for transmitting, by the repeater, a first signal generated by the repeater to the network device.

In some embodiments, the network device indicates and/or configures the second time unit to the repeater, and the second time unit is available for transmitting, by the repeater, a second signal that is not generated by the repeater to the network device.

Only the steps or processes related to the present disclosure are illustrated hereinabove, but the present disclosure is not limited to this. The method of the embodiments of the present disclosure may also include other steps or processes, and the details of these steps or processes can be seen by referring to the related art.

The embodiments above only schematically illustrate the embodiments of the present disclosure, but the present disclosure is not limited to this, and appropriate variations can also be made on the basis of the above embodiments. For example, the above embodiments may be used separately, or one or more of the above embodiments may be combined.

In accordance with the embodiments of the present disclosure, the frequency resources for communication and forwarding between the repeater and the network device may be configured by the network device, so that the forwarding of the repeater may be configured according to the real-time condition of the network, which may better enhance signal coverage and cope with changes in the environment and the main business in the cell, so as to improve the transmission efficiency of the entire network.

### Embodiments of Fourth Aspect

An embodiment of the present disclosure provides a network device.

FIG. 27 is a schematic diagram of a network device in the embodiment of the present disclosure. Since the principle for the network device to solve the problem is the same as the method of the embodiments of the third aspect, the specific implementation can be realized referring to the embodiments of the third aspect, and the same contents are not repeated.

As shown in FIG. 27, a network device 2700 of the embodiments of the present disclosure includes:

a transmitting portion 2701 configured to indicate and/or configure a first frequency resource and/or a second frequency resource to a repeater,
wherein the first frequency resource is used for the repeater to transmit a first signal generated by the repeater to the network device, and the second frequency resource is used for the repeater to transmit a second signal not generated by the repeater to the network device.

In some embodiments, as shown in FIG. 27, the network device 2700 may further include:
a receiving portion 2702 configured to receive the first signal transmitted by the repeater, and/or receive the second signal forwarded by the repeater.

It is worth noting that only the components or modules related to the present disclosure are illustrated hereinabove, but the present disclosure is not limited to this. The network device 2700 of the embodiments of the present disclosure may also include other components or modules, and the details of these components or modules can be seen by referring to the related art.

In addition, for the sake of simplicity, FIG. 27 only exemplarily shows the connection relationship or signal trend between the individual components or modules, but it should be clear to those skilled in the art that various related techniques such as bus connections can be employed. The above individual components or modules can be implemented by hardware facilities such as a processor, a memory, a transmitter, a receiver, etc., which is not limited in the present disclosure.

The embodiments above only schematically illustrate the embodiments of the present disclosure, but the present disclosure is not limited to this, and appropriate variations can also be made on the basis of the above embodiments. For example, the above embodiments may be used separately, or one or more of the above embodiments may be combined.

In accordance with the embodiments of the present disclosure, the frequency resources for communication and forwarding between the repeater and the network device may be configured by the network device, so that the forwarding of the repeater may be configured according to the real-time condition of the network, which may better enhance signal coverage and cope with changes in the environment and the main business in the cell, so as to improve the transmission efficiency of the entire network.

### Embodiments of Fifth Aspect

An embodiment of the present disclosure provides a communication system. FIG. 1 is a schematic diagram of the communication system of the embodiment of the present disclosure. As shown in FIG. 1, a communication system 100 includes a network device 101, a repeater 102 and a terminal equipment 103. For the sake of simplicity, FIG. 1 gives exemplary illustration by taking only one network device, one repeater and one terminal equipment as an example, but the embodiment of the present disclosure is not limited to this.

In the embodiments of the present disclosure, existing services or services that may be implemented in the future may be transmitted between the network device 101 and the terminal equipment 103. For example, these services may include, but are not limited to, enhanced mobile broadband (eMBB), large-scale machine-type communications (mMTC), highly reliable low-latency communications (URLLC), and vehicle-to-vehicle (V2X) communications. The repeater 102 is configured to perform the communication method described in the embodiments of the first aspect, the network device 101 is configured to perform the communication method described in the embodiments of the third aspect, the contents thereof are incorporated here and will not be described here.

The embodiments of the present disclosure further provides an electronic device. The electronic device is, for example, a repeater or a network device.

FIG. 28 is a schematic diagram of composition of an electronic device in the embodiments of the present disclosure. As shown in FIG. 28, an electronic device 2800 may include a processor 2810 (such as a central processing unit (CPU)) and a memory 2820; the memory 2820 is coupled to the processor 2810. The memory 2820 may store various data and may also store the information processing program 2830, and the program 2830 is executed under the control of the processor 2810.

For example, the processor 2810 may be configured to execute the program to implement the communication method as described in the embodiments of the first aspect. For example, the processor 2810 may be configured to perform the following control of: receiving first indication information from a network device, the first indication information being used to indicate and/or configure a first frequency resource and/or a second frequency resource, wherein the first frequency resource is used for the repeater to transmit a first signal generated by the repeater to the network device, and the second frequency resource is used for the repeater to transmit a second signal not generated by the repeater to the network device.

For another example, the processor 2810 may be configured to execute the program to implement the communication method as described in the embodiments of the third aspect. For example, the processor 2810 may be configured to perform the following control of: indicating and/or configuring a first frequency resource and/or a second frequency resource to a repeater, wherein the first frequency resource is used for the repeater to transmit a first signal generated by the repeater to the network device, and the second frequency resource is used for the repeater to transmit a second signal not generated by the repeater to the network device.

In addition, as shown in FIG. 28, the electronic device 2800 may further include: a transceiver 2840 and an antenna 2850, etc., wherein the functions of the above components are similar to the related art, and will not be repeated here. It is worth noting that the electronic device 2800 is not necessarily required to include all of the components shown in FIG. 28; in addition, the electronic device 2800 may further include components not shown in FIG. 28, with reference to the related art.

The embodiments of the present disclosure further provide a computer readable program which, when being executed in the repeater, causes a computer to execute the communication method described in the embodiments of the first aspect in the repeater.

The embodiments of the present disclosure further provide a storage medium storing a computer readable program which causes the computer to execute the communication method described in the embodiments of the first aspect in the repeater.

The embodiments of the present disclosure further provide a computer readable program which, when being executed in the network device, causes the computer to execute the communication method described in the embodiments of the third aspect in the network device.

The embodiments of the present disclosure further provide a storage medium storing a computer readable program which causes the computer to execute the communication method described in the embodiments of the third aspect in the network device.

The above devices and methods of the present disclosure can be implemented by hardware or by hardware combined with software. The present disclosure relates to a computer readable program which, when being executed by a logic unit, enables the logic unit to implement the devices or components mentioned above, or enables the logic unit to implement the methods or steps described above. The logic unit is, for example, a field programmable logic unit, a microprocessor, a processor used in the computer, etc. The present disclosure also relates to storage medium for storing the above programs, such as a hard disk, a magnetic disk, a compact disc, a DVD, a flash memory.

The method/device described in conjunction with the embodiments of the present disclosure may be directly embodied as hardware, a software module executed by the processor, or a combination of both. For example, one or more of the functional block diagrams and/or combination thereof shown in the drawing may correspond to both software modules and hardware modules of the computer program flow. These software modules can correspond to the steps shown in the drawings respectively. These hardware modules can be realized, for example, by solidifying these software modules using field programmable gate arrays (FPGA).

The software module may reside in an RAM memory, a flash memory, an ROM memory, an EPROM memory, an EEPROM memory, a register, a hard disk, a removable disk, a CD-ROM, or a storage medium in any other form known in the art. A storage medium can be coupled to a processor so that the processor can read information from the storage medium and write information to the storage medium; or the storage medium can be a constituent part of the processor. The processor and the storage medium can be located in the ASIC. The software module can be stored in the memory of the mobile terminal or in a memory card that can be inserted into the mobile terminal. For example, if a device (such as a mobile terminal) uses a large-capacity MEGA-SIM card or a large-capacity flash memory device, the software module can be stored in the MEGA-SIM card or the large-capacity flash memory device.

One or more of the functional blocks and/or combination thereof shown in the drawing may be implemented as a general-purpose processor, a digital signal processor (DSP), an application-specific integrated circuit (ASIC), a field programmable gate array (FPGA) or other programmable logic device, a discrete gate or a transistor logic device, a discrete hardware component, or any appropriate combination thereof, for performing the functions described in the present disclosure. One or more of the functional blocks and/or combination thereof shown in the drawing may also be implemented as combination of computing devices, such as combination of DSP and a microprocessor, multiple microprocessors, one or more microprocessors combined with DSP communication, or any other such configuration.

The present disclosure is described in combination with specific embodiments hereinabove, but a person skilled in the art should know clearly that the description is exemplary, but not limitation to the protection scope of the present disclosure. A person skilled in the art can make various variations and modifications to the present disclosure according to spirit and principle of the application, and these variations and modifications should also be within the scope of the present disclosure.

With respect to the above-mentioned embodiments disclosed in the embodiment, the following supplements are further disclosed:
1. A communication method of a network device, including:
indicating and/or configuring, by a network device, a first frequency resource and/or a second frequency resource to a repeater,
wherein the first frequency resource is used for the repeater to transmit a first signal generated by the repeater to the network device, and the second frequency resource is used for the repeater to transmit a second signal not generated by the repeater to the network device.
2. The method according to the supplement 1, wherein the method further includes:
the network device indicates and/or configures a third frequency resource and/or a fourth frequency resource to the repeater,
wherein the third frequency resource is used for the repeater to receive a third signal transmitted by the network device to the repeater, and the fourth frequency resource is used for the repeater to receive a fourth signal from the network device that is to be forwarded by the repeater.
3. The method according to the supplement 1, wherein the second signal is obtained by the repeater at least by amplifying a signal received by the repeater at the second frequency resource.
4. The method according to the supplement 2, wherein the third signal is used to carry information and/or data transmitted by the network device to the repeater, or the third signal is used to configure the repeater to perform channel estimation and/or measurement.
5. The method according to the supplement 2, wherein the fourth signal is a signal received by the repeater at the fourth frequency resource, and is forwarded by the repeater after at least being amplified by the repeater.
6. The method according to any of the supplements 1 to 5, wherein the first frequency resource and/or the second frequency resource are indicated and/or configured in the first cell of the network device, for the repeater.
7. The method according to the supplement 2, wherein the third frequency resource and/or the fourth frequency resource are indicated and/or configured in the first cell of the network device, for the repeater.
8. The method according to the supplement 6 or 7, wherein the first cell is a serving cell of the repeater.
9. The method according to the supplement 8, wherein the first cell is a primary cell of the repeater.
10. The method according to any of the supplements 6 to 9, wherein,
the first cell is a cell where the repeater performs initial access; and/or,
the first cell is a cell where the repeater establishes RRC connection with the network device; and/or,
the first cell is a cell where the repeater reestablishes RRC connection with the network device; and/or,
the first cell is a cell where the repeater camps; and/or,
the first cell is a cell selected by the repeater in a cell selection process or in a cell reselection process.
11. The method according to any of the supplements 1 to 10, wherein the first signal includes at least one of the following: a physical uplink shared channel (PUSCH), a demodulation reference signal (DMRS), a sounding reference signal (SRS), a physical random access channel (PRACH), a physical uplink control channel (PUCCH), or a scheduling request (SR).
12. The method according to the supplement 11, wherein the first signal is generated by the repeater by at least using a cell ID of the first cell, or generation of the first signal is related to the cell ID of the first cell.
13. The method according to the supplement 12, wherein the first signal includes DMRS, and the sequence generation of the DMRS is related to the cell ID, and/or, the first signal includes PUSCH, and the scrambler sequence of the PUSCH is related to the cell ID.
14. The method according to any of the supplements 1 to 13, wherein the first frequency resource overlaps the second frequency resource, or the first frequency resource does not overlap the second frequency resource.
15. The method according to any of the supplements 1 to 14, wherein the first frequency resource is an uplink carrier to which a first cell corresponds, or an uplink bandwidth part (BWP) configured and/or indicated by the network device for the repeater, or an active uplink BWP configured by the network device for the repeater.
16. The method according to any of the supplements 1 to 15, wherein the second frequency resource at least includes a frequency resource other than the first frequency resource.
17. The method according to the supplement 16, wherein the second frequency resource contains the first frequency resource, or the second frequency resource does not contain the first frequency resource.
18. The method according to any of the supplements 1 to 15, wherein the second frequency resource and the first frequency resource are the same.
19. The method according to any of the supplements 1 to 18, wherein the network device indicates the first frequency resource and/or the second frequency resource to the repeater via RRC signaling or MAC signaling or a physical layer control channel.
20. The method according to any of the supplements 1 to 19, wherein the signaling or information element (IE) used to indicate the second frequency resource is different from the signaling or information element (IE) used to indicate the first frequency resource.
21. The method according to any of the supplements 1 to 20, wherein the network device further indicates to the repeater a starting frequency/frequencies and an ending frequency/frequencies of the first frequency resource and/or the second frequency resource, or a center frequency/frequencies and a bandwidth(s) of the first frequency resource and/or the second frequency resource, or a starting frequency/frequencies and bandwidth(s) of the first frequency resource and/or the second frequency resource.
22. The method according to any of the supplements 1 to 21, wherein the network device indicates or configures the repeater to transmit the first signal to the network device using a first spatial filter; and the first spatial filter is also used by the repeater to transmit the second signal to the network device.
23. The method according to the supplement 2, wherein the third frequency resource overlaps the fourth frequency resource, or the third frequency resource does not overlap the fourth frequency resource.
24. The method according to the supplement 2, wherein the third frequency resource is a downlink carrier to which a first cell corresponds, or a downlink bandwidth part (BWP) configured and/or indicated by the network device for the repeater, or an active downlink BWP configured by the network device for the repeater.
25. The method according to the supplement 2, wherein the fourth frequency resource at least includes a frequency resource other than the third frequency resource.
26. The method according to the supplement 25, wherein the fourth frequency resource contains the third frequency resource, or the fourth frequency resource does not contain the third frequency resource.
27. The method according to the supplement 2, wherein the fourth frequency resource and the third frequency resource are the same.
28. The method according to the supplement 2, wherein the network device indicates the third frequency resource and/or the fourth frequency resource to the repeater via RRC signaling or MAC signaling or a physical layer control channel.
29. The method according to the supplement 2, wherein the signaling or information element (IE) used to indicate the fourth frequency resource is different from the signaling or information element (IE) used to indicate the third frequency resource.
30. The method according to the supplement 2, wherein the network device further indicates to the repeater a starting frequency/frequencies and an ending frequency/frequencies of the third frequency resource and/or the fourth frequency resource, or a center frequency/frequencies and a bandwidth(s) of the third frequency resource and/or the fourth frequency resource, or a starting frequency/frequencies and bandwidth(s) of the third frequency resource and/or the fourth frequency resource.
31. The method according to the supplement 2, wherein the network device indicates or configures the repeater to receive the third signal transmitted by the network device using a second spatial filter; and the second spatial filter is also used for the repeater to receive the fourth signal transmitted by the network device.
32. The method according to the supplement 2, wherein a center frequency of the fourth frequency resource is identical to a center frequency of the second frequency resource, and/or, a bandwidth of the fourth frequency resource is greater than a bandwidth of the second frequency resource.
33. The method according to the supplement 2, wherein the second frequency resource and/or the fourth frequency resource are/is predefined or preconfigured, and/or, the second frequency resource and/or the fourth frequency resource are/is not indicated by a signaling, and/or, the second frequency resource and/or the fourth frequency resource are/is indicated or configured by an operation administration and maintenance (OAM).
34. The method according to any of the supplements 1 to 33, wherein the method further includes:
the network device indicates and/or configures the first time unit to the repeater, and the first time unit is available for transmitting, by the repeater, a first signal generated by the repeater to the network device.
35. The method according to any of the supplements 1 to 34, wherein the method further includes:
the network device indicates and/or configures the second time unit to the repeater, and the second time unit is available for transmitting, by the repeater, a second signal that is not generated by the repeater to the network device.
36. A communication method of a repeater, including:
receiving, by a repeater, first indication information from a network device, the first indication information being used to indicate and/or configure a first frequency resource and/or a second frequency resource,
wherein the first frequency resource is used for the repeater to transmit a first signal generated by the repeater to the network device, and the second frequency resource is used for the repeater to transmit a second signal not generated by the repeater to the network device.
37. The method according to the supplement 36, wherein the first indication information is further used to indicate and/or configure a third frequency resource and/or a fourth frequency resource, wherein the third frequency resource is used for the repeater to receive a third signal transmitted by the network device to the repeater, and the fourth frequency resource is used for the repeater to receive a fourth signal from the network device that is to be forwarded by the repeater.
38. The method according to the supplement 36, wherein the second signal is obtained by the repeater at least by amplifying a signal received by the repeater at the second frequency resource.
39. The method according to the supplement 37, wherein the third signal is used to carry information and/or data transmitted by the network device to the repeater, or the third signal is used to configure the repeater to perform channel estimation and/or measurement.
40. The method according to the supplement 37, wherein the fourth signal is a signal received by the repeater at the fourth frequency resource, and is forwarded by the repeater after at least being amplified by the repeater.
41. The method according to any of the supplements 36 to 40, wherein the repeater receives the first indication information at a first cell of the network device.
42. The method according to the supplement 37, wherein the repeater receives the first indication information at the first cell of the network device.
43. The method according to the supplement 41 or 42, wherein the first cell is a serving cell of the repeater.
44. The method according to the supplement 43, wherein the first cell is a primary cell of the repeater.
45. The method according to any of the supplements 41 to 44, wherein,
the first cell is a cell where the repeater performs initial access; and/or,
the first cell is a cell where the repeater establishes RRC connection with the network device; and/or,
the first cell is a cell where the repeater reestablishes RRC connection with the network device; and/or,
the first cell is a cell where the repeater camps; and/or,
the first cell is a cell selected by the repeater in a cell selection process or in a cell reselection process.
46. The method according to any of the supplements 36 to 45, wherein the first signal includes at least one of the following: a physical uplink shared channel (PUSCH), a demodulation reference signal (DMRS), a sounding reference signal (SRS), a physical random access channel (PRACH), a physical uplink control channel (PUCCH), or a scheduling request (SR).
47. The method according to the supplement 46, wherein the first signal is generated by the repeater by at least using a cell ID of the first cell, or generation of the first signal is related to the cell ID of the first cell.
48. The method according to the supplement 47, wherein the first signal includes DMRS, and the sequence generation of the DMRS is related to the cell ID, and/or, the first signal includes PUSCH, and the scrambler sequence of the PUSCH is related to the cell ID.
49. The method according to any of the supplements 36 to 48, wherein the signal received by the repeater at the second frequency resource at least includes a signal from a third device, the signal from the third device being generated and transmitted by the third device according to an indication of the network device.
50. The method according to the supplement 49, wherein the signal from the third device is related to a cell identifier (ID) of the first cell.
51. The method according to the supplement 50, wherein the first cell is a serving cell of the third device, or the first cell is a serving cell of the third device.
52. The method according to any of the supplements 36 to 51, wherein the first frequency resource overlaps the second frequency resource, or the first frequency resource does not overlap the second frequency resource.
53. The method according to any of the supplements 36 to 52, wherein the first frequency resource is an uplink carrier to which a first cell corresponds, or an uplink bandwidth part (BWP) configured and/or indicated by the network device for the repeater, or an active uplink BWP configured by the network device for the repeater.
54. The method according to any of the supplements 36 to 53, wherein the second frequency resource at least includes a frequency resource other than the first frequency resource.
55. The method according to the supplement 54, wherein the second frequency resource contains the first frequency resource, or the second frequency resource does not contain the first frequency resource.
56. The method according to any of the supplements 36 to 53, wherein the second frequency resource and the first frequency resource are the same.
57. The method according to any of the supplements 36 to 56, wherein the first frequency resource and/or the second frequency resource are indicated via RRC signaling or MAC signaling or a physical layer control channel.
58. The method according to any of the supplements 36 to 57, wherein the signaling or information element (IE) used to indicate the second frequency resource is different from the signaling or information element (IE) used to indicate the first frequency resource.
59. The method according to any of the supplements 36 to 58, wherein the first indication information further indicates: a starting frequency/frequencies and an ending frequency/frequencies of the first frequency resource and/or the second frequency resource, or a center frequency/frequencies and a bandwidth(s) of the first frequency resource and/or the second frequency resource, or a starting frequency/frequencies and bandwidth(s) of the first frequency resource and/or the second frequency resource.
60. The method according to any of the supplements 36 to 59, wherein the repeater transmits the first signal to the network device by using a first spatial filter, the first spatial filter being further used by the repeater to transmit the second signal to the network device.
61. The method according to the supplement 37, wherein the third frequency resource overlaps the fourth frequency resource, or the third frequency resource does not overlap the fourth frequency resource.
62. The method according to the supplement 37, wherein the third frequency resource is a downlink carrier to which a first cell corresponds, or a downlink bandwidth part (BWP) configured and/or indicated by the network device for the repeater, or an active downlink BWP configured by the network device for the repeater.
63. The method according to the supplement 37, wherein the fourth frequency resource at least includes a frequency resource other than the third frequency resource.
64. The method according to the supplement 63, wherein the fourth frequency resource contains the third frequency resource, or the fourth frequency resource does not contain the third frequency resource.
65. The method according to the supplement 37, wherein the fourth frequency resource and the third frequency resource are the same.
66. The method according to the supplement 37, wherein the third frequency resource and/or the fourth frequency resource are indicated via RRC signaling or MAC signaling or a physical layer control channel.
67. The method according to the supplement 37, wherein the signaling or information element (IE) used to indicate the fourth frequency resource is different from the signaling or information element (IE) used to indicate the third frequency resource.
68. The method according to the supplement 37, the first indication information further indicates: a starting frequency/frequencies and an ending frequency/frequencies of the third frequency resource and/or the fourth frequency resource, or a center frequency/frequencies and a bandwidth(s) of the third frequency resource and/or the fourth frequency resource, or a starting frequency/frequencies and bandwidth(s) of the third frequency resource and/or the fourth frequency resource.
69. The method according to the supplement 37, wherein the repeater receives the third signal transmitted by the network device using a second spatial filter; and the second spatial filter is also used for the repeater to receive the fourth signal transmitted by the network device.
70. The method according to the supplement 37, wherein a center frequency of the fourth frequency resource is identical to a center frequency of the second frequency resource, and/or, a bandwidth of the fourth frequency resource is greater than a bandwidth of the second frequency resource.
71. The method according to the supplement 37, wherein the second frequency resource and/or the fourth frequency resource are/is predefined or preconfigured, and/or, the second frequency resource and/or the fourth frequency resource are/is not indicated by a signaling, and/or, the second frequency resource and/or the fourth frequency resource are/is indicated or configured by an operation administration and maintenance (OAM).
72. The method according to any of the supplements 36 to 71, wherein the method further includes:
the repeater receives second indication information from the network device, the second indication information is used to indicate and/or configure a first time unit and/or a second time unit, the first time unit is available for transmitting, by the repeater, a first signal generated by the repeater to the network device, and the second time unit is available for transmitting, by the repeater, a second signal that is not generated by the repeater to the network device.
73. A repeater including a memory storing a computer program and a processor configured to execute the computer program to implement the communication method according to any of the supplements 36 to 72.
74. A network device including a memory storing a computer program and a processor configured to execute the computer program to implement the communication method according to any of the supplements 1 to 35.

What is claimed is:

1. A communication method of a repeater, comprising:
receiving first indication information from a network device, the first indication information being used to indicate and/or configure a first frequency resource and/or a third frequency resource, wherein the first frequency resource is used to transmit, by the repeater, a first communication signal generated by the repeater to the network device, the third frequency resource is used to receive, by the repeater, a third communication signal transmitted by the network device to the repeater;
when receiving a sixth forwarding signal from a terminal equipment:
amplifying the sixth forwarding signal and obtaining a second forwarding signal; and
forwarding the second forwarding signal to the network device, and
when receiving a fourth forwarding signal from the network device:
amplifying the fourth forwarding signal and obtaining a fifth forwarding signal, and
forwarding the fifth forwarding signal to the terminal equipment.

2. The communication method according to claim 1, wherein the first indication information is carried by a radio resource control (RRC) signal and/or a physical downlink control channel (PDCCH) and/or media access control (MAC) control element (CE).

3. The communication method according to claim 1, wherein the first frequency resource is an uplink carrier to which a first cell corresponds, or an uplink bandwidth part (BWP), or an active uplink BWP configured for the repeater;
the third frequency resource is a downlink carrier to which the first cell corresponds, or a downlink BWP, or an active downlink BWP configured for the repeater.

4. The communication method according to claim 1, wherein
a beam used for receiving the fourth forwarding signal is indicated or configured by the network device to the repeater or is predefined, a beam used for transmitting the second forwarding signal is indicated or configured by the network device to the repeater or is predefined;
a beam used for receiving the sixth forwarding signal is indicated or configured by the network device to the repeater, a beam used for transmitting the fifth forwarding signal is indicated or configured by the network device to the repeater.

5. The communication method according to claim 1, wherein
a spatial filter used for transmitting the first communication signal is reused as a beam for transmitting the second forwarding signal, and/or,
a spatial filter used for receiving the third communication signal from the network device is reused as a beam for receiving the fourth forwarding signal.

6. The communication method according to claim 1, wherein the method further comprises:
receiving third indication information and/or fourth indication information from the network device, the third indication information being used to configure and/or indicate a spatial filter and/or a transmission configuration indication (TCI) for transmitting a first communication signal by the repeater, the fourth indication information being used to configure and/or indicate a spatial filter and/or a TCI for receiving a third communication signal from the network device by the repeater.

7. The communication method according to claim 1, wherein the repeater receives at least one of the first indication information, third indication information or fourth indication information, at a first cell of the network device;
wherein the first cell is a serving cell of the repeater.

8. The communication method according to claim 1, wherein the first communication signal comprises at least one of the following: a physical uplink shared channel (PUSCH), a demodulation reference signal (DMRS), a sounding reference signal, a physical random access channel, a physical uplink control channel, a scheduling request;
wherein a scrambling sequence of the PUSCH is related to an identifier of a first cell, or a sequence generation of the DMRS is related to an identifier of the first cell.

9. The communication method according to claim 1, wherein the third communication signal comprises at least one of the following: a physical downlink shared channel (PDSCH), a physical downlink control channel (PDCCH), Synchronization Signal Block (SSB), Channel State Information Reference Signal (CSIRS).

10. The communication method according to claim 1, wherein the third communication signal is related to a radio network temporary identifier (RNTI) of the repeater.

11. The communication method according to claim 1, wherein the repeater receives the fourth forwarding signal at a fourth frequency resource, the repeater transmits the second forwarding signal at a second frequency resource.

12. The communication method according to claim 11, wherein
the second frequency resource at least includes a frequency resource other than the first frequency resource, the second frequency resource contains the first frequency resource, or, the second frequency resource does not contain the first frequency resource, or
the second frequency resource is identical to the first frequency resource, or
the second frequency resource and the first frequency resource are located in different bands.

13. The communication method according to claim 11, wherein
the fourth frequency resource at least includes a frequency resource other than the third frequency resource, the fourth frequency resource contains the third frequency resource, or the fourth frequency resource does not contain the third frequency resource, or,
the fourth frequency resource is identical to the third frequency resource, or
the fourth frequency resource and the third frequency resource are located in different bands.

14. The communication method according to claim 11, wherein a center frequency of the fourth frequency resource is identical to a center frequency of the second frequency resource, and/or, a bandwidth of the fourth frequency resource is greater than a bandwidth of the second frequency resource.

15. The communication method according to claim 11, wherein the second frequency resource and/or the fourth frequency resource are/is predefined or preconfigured, and/or, the second frequency resource and/or the fourth frequency resource are/is not indicated by a signaling, and/or, the second frequency resource and/or the fourth frequency resource are/is indicated or configured by an operation administration and maintenance (OAM) entity.

16. The communication method according to claim 11, wherein the second frequency resource and the fourth frequency resource are indicated by the first indication information;
wherein the first indication information indicates: a starting frequency/frequencies and an ending frequency/frequencies of the second frequency resource and/or the fourth frequency resource, or a center frequency/frequencies and a bandwidth(s) of the second frequency resource and/or the fourth frequency resource, or a starting frequency/frequencies and bandwidth(s) of the second frequency resource and/or the fourth frequency resource.

17. A repeater comprising:
a receiver configured to:
receive first indication information from a network device, the first indication information being used to indicate and/or configure a first frequency resource and/or a third frequency resource, the first frequency resource is used by the repeater to transmit a first communication signal generated by the repeater to the network device, the third frequency resource is used by the repeater to receive a third communication signal transmitted by the network device to the repeater, and
receive a sixth forwarding signal from a terminal equipment; and
a transmitter configured to:
amplify the sixth forwarding signal and obtain a second forwarding signal, and
forward the second forwarding signal to the network device, wherein
the receiver is further configured to receive a fourth forwarding signal from the network device, and
the transmitter configured to
amplify the fourth forwarding signal, and obtain a fifth forwarding signal, and
forward the fifth forwarding signal to the terminal equipment.
